(19) United States
(12) Patent Application Publication
(10) Pub. No.: US 2007/0097278 A1
(43) Pub. Date: May 3, 2007

(54) DISPLAY SUBSTRATE, METHOD OF MANUFACTURING THE SAME AND DISPLAY PANEL HAVING THE SAME

(75) Inventors: Soo-Guy RHO, Suwon-si (KR); Jin JEON, Suwon-si (KR); Ji-Eun LEE, Seoul (KR); Sang-Jin PAK, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/556,297

(22) Filed: Nov. 3, 2006

(30) Foreign Application Priority Data
Nov. 3, 2005 (KR) 1020050104885
Dec. 6, 2005 (KR) 1020050117933

(51) Int. Cl. G02F 1/1335

(52) U.S. Cl. 349/12

(57) ABSTRACT

A display substrate reducing a cost price and produced conveniently by a simple process includes a base substrate, a supporting pattern, and a first and a second protrusion pattern. The display substrate has a touch screen function detecting a touch point and electrically connected at the touch point to an array substrate having a plurality of pixel portions, and first and second signal lines formed thereon. The supporting pattern is formed on a base substrate with a first length, and maintains a separation distance from the array substrate. The first and second protrusion patterns are formed on the base substrate with a second length, and electrically connected to the first and second signal lines respectively. The protrusion pattern and the supporting pattern are simultaneously formed, and thus the manufacturing process can be simplified.

This application claims priority to Korean Patent Application No. 2005-0104885, filed on Nov. 3, 2005, and Korean Patent Application No. 2005-0117933, filed on Dec. 6, 2005 and all the benefits accruing therefrom under 35 U.S.C. §119, and the contents of which in their entireties are herein incorporated by reference.

### BACKGROUND OF THE INVENTION

1. Field of the Invention

The present invention relates to a display substrate, a method of manufacturing the display substrate, and a display panel having the display substrate. More particularly, the present invention relates to the display substrate capable of reducing a manufacturing cost and enhancing a production convenience by simplifying a manufacturing process, a method of manufacturing the display substrate, and the display panel having the display substrate.

2. Description of the Related Art

Generally, a display apparatus displays an image for a user to recognize data processed by an information processing unit. A flat panel display apparatus has merits such as miniaturization, lightweight structure, high resolution and so on, so that the flat panel display apparatus is widely used.

A liquid crystal display (“LCD”) apparatus is a frequently used flat panel display apparatus. The LCD apparatus displays an image by using a liquid crystal material. The liquid crystal changes a light transmissivity according to electric field intensity applied thereto.

The LCD apparatus includes an LCD panel having an array substrate, an opposite substrate and a liquid crystal layer. The array substrate has a thin film transistor (“TFT”) which is a switching element formed thereon. The opposite substrate is combined with the array substrate. The liquid crystal layer is disposed between the array substrate and the opposite substrate.

Generally, the LCD apparatus has an input part including an operation interface, and a system part processing data inputted by the input part. The LCD apparatus displays an image through a uni-directional communication using a control signal outputted from the system part.

Recently, the LCD apparatus utilizes a touch panel to which a user's instructions are directly inputted by using demonstrated icons of the LCD panel instead of the uni-directional communication.

The touch panel is disposed over the LCD panel, and has the demonstrated icons on the LCD panel screen. When the user touches the demonstrated icons with a finger or a light pen, etc. and selects orders to be performed, the touch panel detects the touch point and drives the LCD apparatus according to the orders that the selected icons have.

The touch panel can be used without an input apparatus such as a keyboard or a mouse when used for a computer, and without an input apparatus such as a keypad when used for a mobile product, so that the touch panel having the touch screen thereon is more and more broadly used.

However, since the touch panel is disposed over the LCD panel, a thickness or a size of the product having the touch panel becomes larger. To solve this problem, the touch panel and the LCD panel are integrally formed.

The LCD panel integrally formed with the touch panel having a light sensor therein is one of the representative examples of touch panels. The light sensor senses an input point from a shadow or a light generated by a light pen, when the finger or the light pen etc. is contacted thereto.

However, when the peripheral light becomes intensive or weakened, a sensitivity of the light senor becomes larger or smaller. Therefore, the LCD panel having the light sensor has a problem that a decision of the touch point is difficult when a peripheral light becomes intensive or weakened.

To solve the above-mentioned problem, a touch screen type LCD panel is developed. The touch screen type LCD panel has a conductive protrusion formed on the opposite substrate. The touch screen type LCD panel also has a detecting line formed on the array substrate corresponding to the conductive structure. Therefore, the touch screen type LCD panel detects a touch point coordination through an electrical short between the conductive protrusion and the detecting line, when a user touches the touch screen type LCD panel.

Therefore, an LCD panel can be more thinly manufactured by embodying the touch screen function through the array substrate and the opposite substrate, and can also detect the touch point coordination more exactly according to a fluctuation of a voltage or a current.

In addition, the LCD panel having the conductive protrusion and the detecting line formed therein to have the touch screen function, further includes a supporting element, in other word, a column spacer which maintains a gap between the array substrate and the opposite substrate and supports both substrates. The conductive protrusion should be formed to have a lower height than that of the column spacer to carry out the touch screen function. Due to the differing heights, the conductive protrusion and the column spacer are hard to be integrally manufactured through one process, and a manufacturing process would be increased.

### BRIEF SUMMARY OF THE INVENTION

The present invention provides a display substrate capable of simplifying a manufacturing process.

The present invention also provides a method of manufacturing the display substrate.

The present invention also provides a display panel having the display substrate.

In exemplary embodiments of a display substrate according to the present invention, the display substrate of a display panel having a touch screen function detecting a coordinate of a touch point, the display substrate electrically connected to an array substrate at the touch point, the array substrate having a plurality of pixel portions, a first line and a second line formed thereon, the plurality of pixel portions defined by a plurality of gate lines and a plurality of data lines, the first and second lines detecting the touch point, includes a base substrate, a supporting pattern, a first protrusion pattern and a second protrusion pattern. The supporting pattern is directly formed on the base substrate with a first length and maintains a uniform separation distance from the array substrate. The first and second protrusion patterns are directly formed on the base substrate with a second length and are electrically connected to the first and second lines respectively in the touch point. The first length may be longer than the second length.

Here, the first and second protrusion patterns may have a conductive layer formed thereon, and the display substrate may further include a color filter layer formed thereon corresponding to the pixel portion.

In exemplary embodiments of a method of manufacturing the exemplary display substrate according to the present invention, the method of manufacturing a display substrate of a display panel having a touch screen function determining a coordinate of a touch point and being electrically connected to an array substrate at the touch point, the array substrate having a plurality of pixel portions, a first line and a second line formed thereon, the plurality of pixel portions defined by a plurality of gate lines and a plurality of data lines, the first and second lines detecting the touch point, includes coating an organic material layer on the base substrate, disposing an exposure mask over an upper portion of the organic material layer and away from the organic material layer, the exposure mask including a first mask pattern and a second mask pattern formed thereon, the first mask pattern forming a supporting pattern, the second mask pattern forming a first protrusion pattern and a second protrusion pattern, exposing the organic material layer while maintaining a uniform separation distance between the exposure mask and the organic material layer, and developing exposed organic material layer to form the supporting pattern and the first and second protrusion patterns.

The method may further include eliminating the organic material layer in an exposed area and forming a color filter layer, forming a conductive layer on an upper portion of the color filter layer, the organic material layer and the light-blocking layer, patterning the conductive layer, and eliminating the conductive layer in an area corresponding to the supporting pattern.

In other exemplary embodiments of methods of manufacturing the exemplary display substrate according to the present invention, the methods of manufacturing a display substrate corresponding to an array substrate having a plurality of pixel portions and signal lines formed thereon, the plurality of pixel portions defined by a plurality of gate lines and a plurality of data lines, the signal lines detecting a touch point, includes forming color filter patterns corresponding to the pixel portions on a base substrate, forming an organic material layer on the base substrate having the color filter patterns formed thereon, patterning the organic material layer, and forming a supporting pattern and a protrusion pattern having a different diameter respectively, forming a transparent electrode layer on the base substrate having the protrusion pattern formed thereon and forming a protrusion electrode covering the protrusion pattern, and forming the supporting pattern and the protrusion pattern having a different height respectively through a heat compressing process on the base substrate having the transparent electrode layer formed thereon.

In still other exemplary embodiments of a method of manufacturing the display substrate according to the present invention, the method of manufacturing a display substrate having a plurality of pixel portions, switching elements and signal lines formed thereon, the plurality of pixel portions defined by a plurality of gate lines and a plurality of data lines, a switching element formed on each pixel portion, the signal lines detecting a touch point, includes forming an organic material layer on a base substrate having the switching elements formed thereon, patterning the organic material layer, and forming a supporting pattern and a protrusion pattern having a different diameter respectively, forming a transparent electrode layer on the base substrate having the supporting pattern and the protrusion pattern formed thereon, patterning the transparent electrode layer and forming a protrusion electrode covering the protrusion pattern and a pixel electrode electrically connected to the switching element, and forming the supporting pattern and the protrusion pattern having a different height respectively through a heat compressing process on the base substrate having the pixel electrode formed thereon.

In still other exemplary embodiments of a display panel according to the present invention, the display panel includes an array substrate and an opposite substrate. The array substrate has a plurality of pixel portions, first signal lines and second signal lines formed thereon, the plurality of pixel portions defined by a plurality of gate lines and a plurality of data lines, the first and second signal lines detecting a touch point and formed in the same direction of the gate lines and the data lines respectively. The opposite substrate is combined with the array substrate, and receives a liquid crystal material.

The opposite substrate includes a light-blocking layer, a supporting pattern, a first protrusion pattern and a second protrusion pattern. The light-blocking layer is formed on a base substrate in areas corresponding to the gate lines and the data lines. The supporting pattern is directly formed on the light-blocking layer with a first length, and maintains a uniform separation distance from the array substrate. The first and second protrusion patterns are directly formed on the light-blocking layer with a second length.

In still other exemplary embodiments of a display substrate according to the present invention, the display substrate of a display panel having a touch screen function detecting a coordinate of a touch point, the display substrate electrically connected to an opposite substrate at the touch point, includes a plurality of pixel portions defined by a plurality of gate lines extending in a first direction and a plurality of data lines extending in a second direction, switching elements formed in the plurality of pixel portions, first signal lines extending in the first direction, second signal lines extending in the second direction, a supporting pattern formed on the switching elements, the supporting pattern having a first length, first and second protrusion patterns formed on the first and second signal lines, respectively, the first and second protrusion patterns having a second length less than the first length, and first and second sensing electrodes formed on the first and second protrusion patterns, respectively, the first and second sensing electrodes electrically connected to the first and second signal lines, respectively.

Therefore, the protrusion pattern carrying out the touch screen function and the supporting pattern supporting the separation distance between the array substrate and the opposite substrate, are integrally formed, and thus the manufacturing process can be simplified.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating an exemplary display apparatus according to an exemplary embodiment of the present invention;

FIG. 2 is a plan view illustrating the exemplary display apparatus in FIG. 1;

FIG. 3 is an exploded perspective view illustrating an exemplary array substrate and an exemplary opposite substrate of the exemplary display apparatus separately in FIG. 2;

FIG. 4 is a plan view illustrating a portion of the exemplary display panel according to an exemplary embodiment of the present invention;

FIG. 5 is a partial cross-sectional perspective view taken along line I-I′ of FIG. 4;

FIG. 6 is a cross-sectional perspective view illustrating a bent shape of the exemplary display panel applied by an external force;

FIG. 7 is a timing chart illustrating an exemplary method for detecting a touch point according to an exemplary embodiment of the present invention;

FIG. 8 is a diagrammatic plan view embodying an exemplary detecting portion for detecting the touch point in FIG. 1 according to the exemplary timing chart in FIG. 7;

FIGS. 9 to 16 are cross-sectional views illustrating an exemplary manufacturing process for the exemplary display substrate according to an exemplary embodiment of the present invention;

FIG. 17 is a graph illustrating a relation between a size of an exemplary mask pattern formed on an exposure mask and a thickness of a remaining layer after an exemplary developing process;

FIG. 18 is a graph illustrating a variation of the thickness of the remaining layer after the exemplary developing process according to a separation distance between the exemplary exposure mask and a photosensitivity macromolecule organic material;

FIG. 19 is a partial cross-sectional view taken along the line I-I′ of FIG. 4 and illustrating the exemplary display panel according to another exemplary embodiment of the present invention;

FIGS. 20 and 21 are cross-sectional views illustrating the exemplary manufacturing process of a protrusion pattern and a supporting pattern in FIG. 19;

FIGS. 22 and 23 are process diagrams illustrating perspective views of an exemplary assembly process of the exemplary display panel;

FIG. 24 is a graph illustrating a variation of strain according to a sectional area of the exemplary supporting pattern when a constant external force is applied thereto;

FIGS. 25A to 25C are conceptual diagrams illustrating a strain process of the exemplary protrusion pattern and the exemplary supporting pattern;

FIG. 26 is a partial cross-sectional view taken along the line I-I′ of FIG. 4 and illustrating the exemplary display panel according to still another exemplary embodiment of the present invention; and

FIGS. 27A and 27B are cross-sectional perspective views illustrating the exemplary manufacturing process of an exemplary protrusion pattern and an exemplary supporting pattern in FIG. 26.

### DETAILED DESCRIPTION OF THE INVENTION

It should be understood that the exemplary embodiments of the present invention described below may be varied modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the embodiments of the present invention will be described in detail with reference to the accompanied drawings.

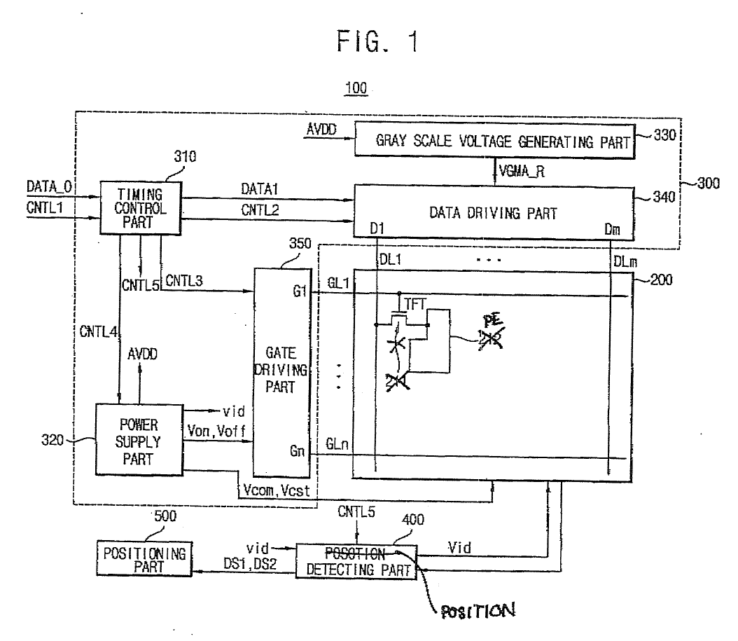

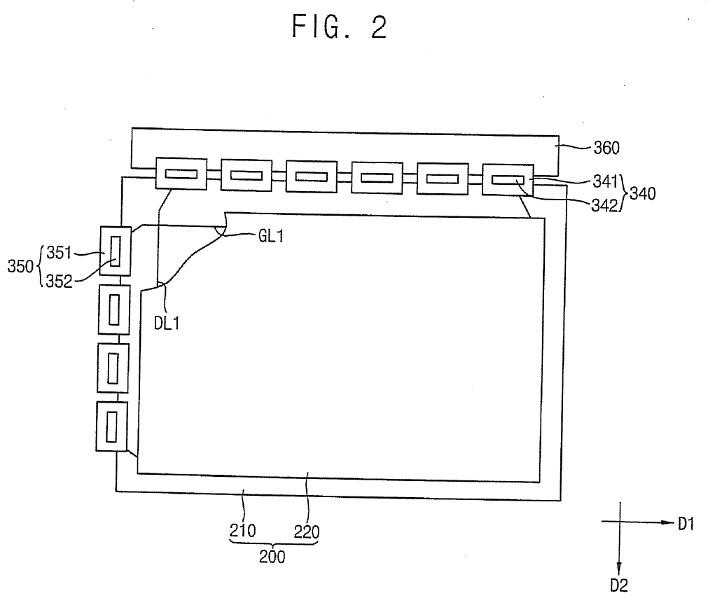

FIG. 1 is a block diagram illustrating an exemplary display apparatus according to an exemplary embodiment of the present invention, and FIG. 2 is a plan view illustrating the exemplary display apparatus in FIG. 1.

Referring to FIGS. 1 and 2, a display substrate 100 includes a display panel 200, a panel driving part 300, a position detecting part 400, and a positioning part 500.

The display panel 200 includes an array substrate 210, an opposite substrate 220, and a liquid crystal layer (not shown). The array substrate 210 has m-number of data lines DL1˜DLm formed in a direction D2 and n-number of gate lines GL1˜GLn formed in a direction D1 formed on the array substrate 210, wherein ‘m’ and ‘n’ are natural numbers. The data lines DL1˜DLm and the gate lines GL1˜GLn are intersected to each other and insulated from each other.

A switching element such as a thin film transistor (“TFT”) is formed on every area where each of the data lines DL1˜DLm and each of the gate lines GL1˜GLn are intersected.

For example, a first switching element TFT1 and a first pixel electrode PE1 are formed on an area where a first data line DL1 and a first gate line GL1 are intersected. A gate electrode of the first switching element TFT1 is electrically connected to the first gate line GL1. A source electrode of the first switching element TFT1 is electrically connected to the first data line DL1. A drain electrode of the first switching element TFT1, formed within the same layer as the source electrode but electrically separated from the source electrode, is electrically connected to the first pixel electrode PE1.

Likewise, the switching element TFT and the pixel electrode PE are respectively formed on an area where a second to an m^{th} data lines DL2 to DLm and a second to an n^{th} gate lines GL2 to GLn are intersected.

In addition, the array substrate 210 has first signal lines and second signal lines formed thereon, as will be further described below, to carry out a touch screen function.

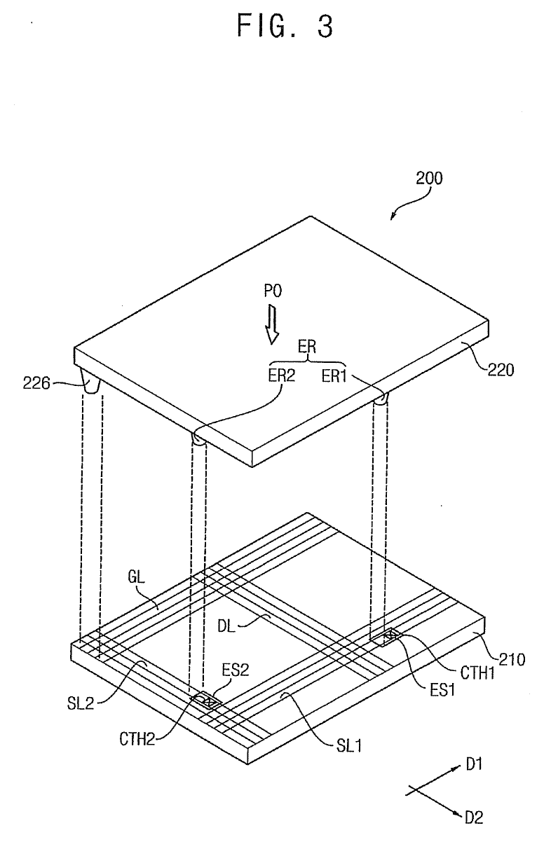

The first signal lines SL1 (as shown in FIG. 3) extend in a first direction D1 as the gate lines GL1˜GLn, and the second signal lines SL2 (as shown in FIG. 3) extend in a second direction D2 as the data lines DL1˜DLm. The first and second signal lines SL1 and SL2 intersect each other, and are electrically insulated from each other.

The first and second signal lines SL1 and SL2 have a driving voltage Vid having a predetermined initial voltage level, and the first and second signal lines SL1 and SL2 are electrically connected to the position detecting part 400.

Here, the first and second signal lines SL1 and SL2 may be formed in every unit pixel having a red (R) pixel, a green (G) pixel and a blue (B) pixel, although alternately colored pixels forming a unit pixel part would also be within the scope of these embodiments, and may also be formed in every plurality of unit pixels. For example, the first and second signal lines SL1 and SL2 may be formed in every four unit pixels.

The opposite substrate 220 is combined with the array substrate 210 such that a liquid crystal layer (not shown) is between the opposite substrate 220 and the array substrate 210. The opposite substrate 220 has a color filter layer formed thereon in every unit pixel and displays a predetermined color. Alternatively, the color filters may be formed on the array substrate 210.

In addition, the opposite substrate 220 has a protrusion electrode part ER formed thereon to carry out the touch screen function. The protrusion electrode part ER has first protrusion electrodes ER1 and second protrusion electrodes ER2 formed thereon. The first and second protrusion electrodes ER1 and ER2 are electrically connected to the first and second signal lines SL1 and SL2, respectively according to an external force applied thereto.

Here, the first and second protrusion electrodes ER1 and ER2 may be formed in every unit pixel having, for example, a red (R) pixel, a green (G) pixel and a blue (B) pixel, and may also be formed in every plurality of unit pixels. For example, the first and second signal lines SL1 and SL2 may be formed in every four unit pixels.

The first and second signal lines SL1 and SL2 formed on the array substrate 210, and the first and second protrusion electrodes ER1 and ER2 formed on the opposite substrate 220, are further described below with reference to FIG. 3.

With reference again to FIG. 1, the panel driving part 300 includes a timing control part 310, a power supply part 320, a gray scale voltage generating part 330, a data driving part 340, and a gate driving part 350.

The timing control part 310 controls an operation of the display apparatus 100. From a host system such as an external graphic controller, an original data signal DATA_0 of the red (R) pixel, the green (G) pixel and the blue (B) pixel, and a first control signal CNTL1, are applied to the timing control part 310. Then, the timing control part 310 controls an output timing of the original data signal DATA_0 to display an image on the display panel 200, and outputs a first data signal DATA1, a second control signal CNTL2, a third control signal CNTL3, a fourth control signal CNTL4, and a fifth control signal CNTL5.

Particularly, the first control signal CNTL1 includes a main clock signal MCLK, a horizontal synchronized signal HSYNC, and a vertical synchronized signal VSYNC. The second control signal CNTL2 includes a horizontal start signal STH, a reversed signal REV, and a data load signal TP to control the data driving part 340. The third control signal CNTL3 includes a start signal STV, a clock signal CK, a print enable signal OE, etc. to control the gate driving part 350. The fourth control signal CNTL4 includes a clock signal CLK, the reversed signal REV, etc. to control the power supply part 320.

The timing control part 310 further outputs the fifth control signal CNTL5 to control the position detecting part 400. The fifth control signal CNTL5 includes a sampling signal SS, etc., for controlling the initial driving power Vid outputted from the power supply part 320 to be applied to the first and second signal lines SL1 and SL2.

The power supply part 320 outputs common voltages Vcom and Vcst, the initial driving voltage Vid, an analog driving voltage AVDD, a gate on/off voltage Von, Voff, etc. in response to the fourth control signal CNTL4 provided from the timing control part 310. The common voltages Vcom and Vcst are applied to the display panel 200. The initial driving voltage Vid is applied to the array substrate 210 to carry out the touch screen function. The analog driving voltage AVDD is applied to the gray scale voltage generating part 330. The on/off voltage Von, Voff is applied to the gate driving part 350.

The gray scale voltage generating part 330 outputs a plurality of reference gray scale voltages VGMA_R corresponding to a gradation level number on the basis of a distribution resistance. The distribution resistance includes a resistance ratio adjusted according to a gamma curvature applied thereto by using the analog driving voltage AVDD as a reference voltage.

The data driving part 340 includes a data tape carrier package (“TCP”) 341 and a data driving chip 342. The m-number of data lines DL may be divided into a plurality of data line blocks, and a plurality of data TCPs 341 may be formed to drive the data line blocks, respectively. The array substrate 210 is electrically connected to a data printed circuit board (“PCB”) 360 on which the timing controlling part 310 may be formed through the data TCP 341.

In addition, the data driving part 340 generates a plurality of gray scale voltages VGMA on the basis of the reference gray scale voltages VGMA_R outputted from the gray scale voltage generation part 330. The data driving part 340 converts the digital type first data signal DATA1 into data signals D1˜Dm of an analog type on the basis of the second control signal CNTL2 provided from the timing control part 310 and the gray scale voltage VGMA, and controls an output timing of the data signals D1˜Dm to output into the data lines DL1˜DLm.

The gate driving part 350 includes a gate TCP 351 and a gate driving chip 352. The n-number of gate lines GL may be divided into a plurality of gate line blocks, and a plurality of gate TCPs 351 may be formed to drive the gate line blocks, respectively.

The gate driving part 350 generates gate signals G1˜Gn in response to the third control signal CNTL3 from the timing control part 310 and the gate on/off voltage Von, Voff from the power supply part 320, and outputs to the gate lines GL1˜GLn.

The position detecting part 400 detects a location, a coordinate, of the external force PO applied to an upper portion of the opposite substrate 220.

For example, when the first protrusion electrodes ER1 formed on the opposite substrate 220 make contact with the first signal lines SL1 formed on the array substrate 210 by the external force PO, a variation of the initial driving voltage Vid applied to the first signal lines SL1 is detected and a Y-axis coordinate of the external force is obtained.

In addition, when the second protrusion electrodes ER2 formed on the opposite substrate 220 make contact with the second signal lines SL2 formed on the array substrate 210 by the external force PO, a variation of the initial driving voltage Vid applied to the second signal lines SL2 is detected and an X-axis coordinate of the external force PO is obtained.

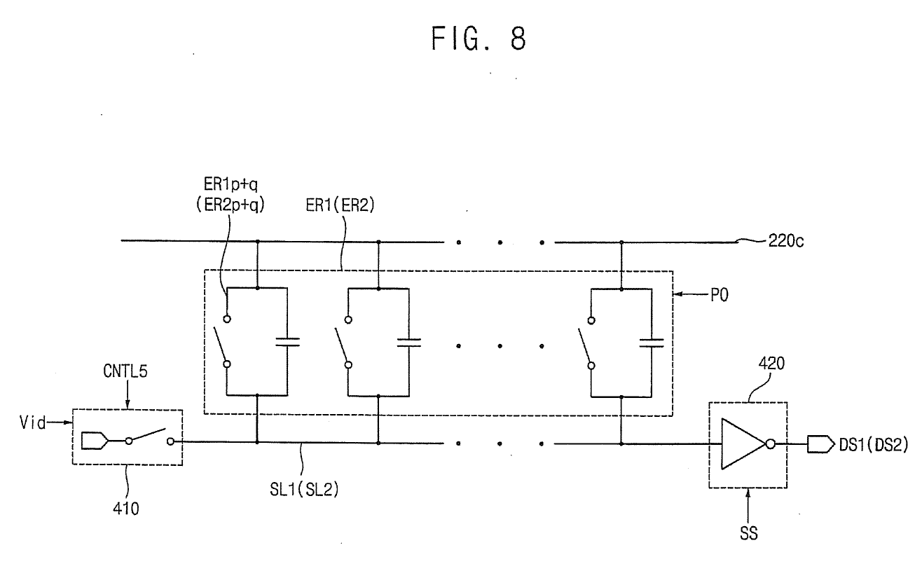

The position detecting part 400 includes a power supply control part and a data sampling part, as will be further described below with respect to FIG. 8. The power supply control part provides the initial driving power Vid to the first and second signal lines SL1 and SL2 in response to the fifth control signal CNTL5. The data sampling part detects the initial driving power Vid in the first and second signal lines SL1 and SL2, and outputs a first detecting signal DS1 and a second detecting signal DS2

The position detecting part 400 may be formed in the data driving part 340 of the panel driving part 300. The position detecting part 400 may be integrally formed with a data driving chip 342 on the data TCP 341 of the data driving part 340. When the position detecting part 400 is integrally formed with the data driving chip 342, the data driving chip 342 may further include additional pads electrically connected to the first and second signal lines SL1 and SL2.

The positioning part 500 processes the X-axis and Y-axis coordinates based on the first and second detecting signals DS1 and DS2 outputted by the position detecting part 400 to determine an exact point on the display panel 200 where the external force PO is applied.

FIG. 3 is an exploded perspective view illustrating an exemplary array substrate and an exemplary opposite substrate of the exemplary display apparatus separately in FIG. 2.

Referring to FIG. 3, the display panel 200 includes the array substrate 210 and the opposite substrate 220.

The array substrate 210 has a plurality of data lines DL formed thereon and extending to a direction D2, and a plurality of gate lines GL formed thereon and extending to a direction D1.

In addition, the array substrate 210 has a plurality of first signal lines SL1 and a plurality of second signal lines SL2 formed thereon to carry out the touch screen function. The first signal lines SL1 extend to the first direction D1, and the second signal lines SL2 extend to the second direction D2.

The array substrate 210 may further include a plurality of sensing electrodes ES formed on an upper portion of the first and second signal lines SL1 and SL2. The sensing electrodes ES include first and second sensing electrodes ES1 and ES2 electrically connected to the first and second signal lines SL1 and SL2 through contact holes CTH 1 and CTH 2, respectively.

The opposite substrate 220 has a plurality of protrusion electrodes ER and a plurality of supporting patterns 226. The protrusion electrodes ER have a first length to carry out the touch screen function. A plurality of the supporting patterns 226 has a second length to maintain a separation distance, such as the cell gap, between the array substrate 210 and the opposite substrate 220. The protrusion electrodes ER and the supporting patterns 226 are directly formed on the base substrate of the opposite substrate 220 to contact the base substrate included in the array substrate 210.

The protrusion electrodes ER include first protrusion electrodes ER1 electrically connectable to the first signal lines SL1, and second protrusion electrodes ER2 electrically connectable to the second signal lines SL2. The first protrusion electrodes ER1 are formed on the opposite substrate 220 such that the first protrusion electrodes ER1 correspond to the first sensing electrode ES1, and the second protrusion electrodes ER2 are formed on the opposite substrate 220 such that the second protrusion electrodes ER2 correspond to the second sensing electrode ES2.

Since the first length of the protrusion electrode ER is smaller than that of the second length of the supporting pattern 226, the first protrusion electrodes ER1 electrically contact the first sensing electrode ES1 and the second protrusion electrodes ER2 electrically contact the second sensing electrode ES2 when an external force PO is applied thereto.

Therefore, upon application of the external force PO, the first and second signal lines SL1 and SL2, which are electrically connected with the first and second sensing electrodes ES1 and ES2, respectively, are electrically connected with the first and second protrusion electrodes ER1 and ER2, respectively.

In addition, the common voltage Vcom outputted from the power supply part 320 illustrated in FIG. 1, is applied to the protrusion electrodes ER. The initial driving voltage Vid outputted from the power supply part 320, is applied to the first and second signal lines SL1 and SL2. Since the protrusion electrodes ER applied with the common voltage Vcom electrically contacts the sensing electrode ES by the external force PO, a potential of the initial driving voltage Vid applied to the first and second signal lines SL1 and SL2 in the contacting point, is changed.

The potential change of the initial driving voltage Vid in the first signal line SL1 is used for determining the Y-axis, or the first direction D1, coordinate. The potential change of the initial driving voltage Vid in the second signal line SL2 is used for determining the X-axis, or the second direction D2, coordinate.

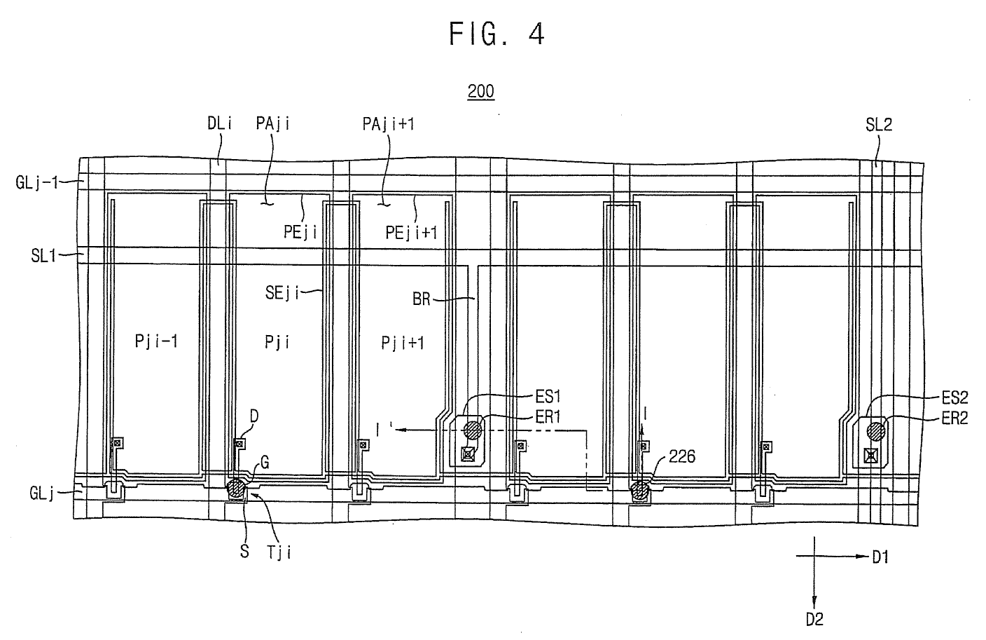

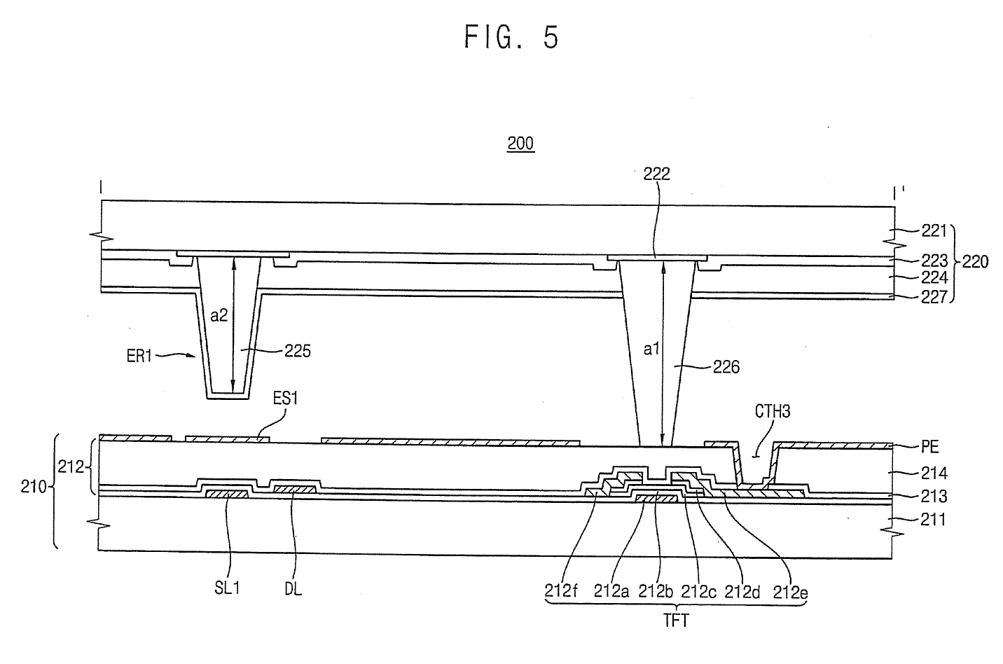

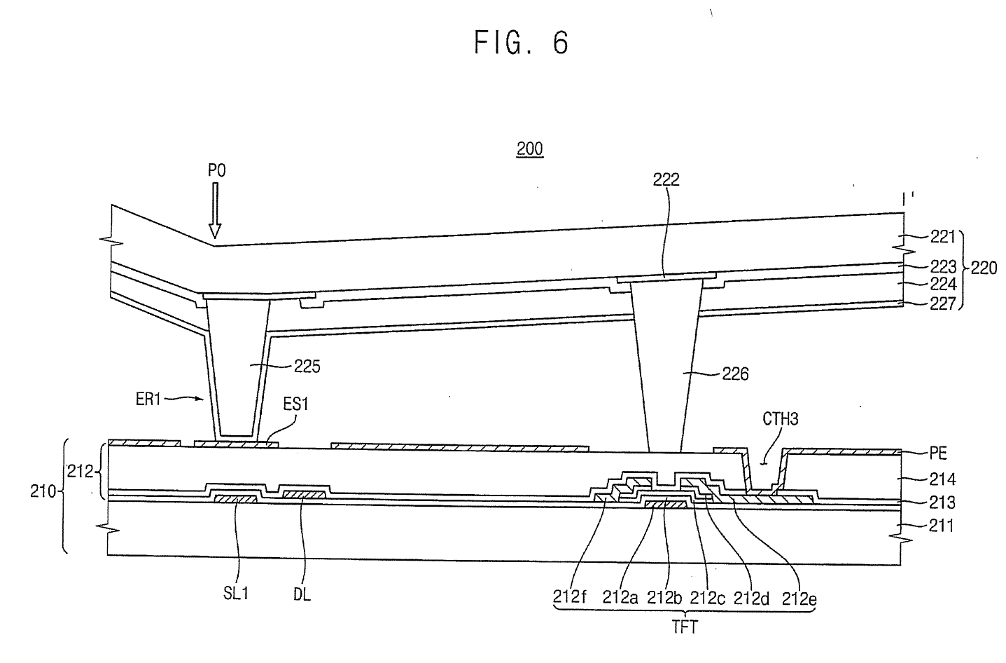

FIG. 4 is a plan view illustrating a portion of the exemplary display panel according to an exemplary embodiment of the present invention, FIG. 5 is a partial cross-sectional view taken along line I-I′ of FIG. 4, and FIG. 6 is a cross-sectional view illustrating a bent shape of the exemplary display panel applied by an external force.

Referring to FIGS. 4 and 5, the display substrate 200 includes the array substrate 210, the opposite substrate 220 and the liquid crystal (not shown) layer disposed between the array substrate 210 and the opposite substrate 220.

The array substrate 210 has a plurality of pixels, which is a standard unit for displaying the image on the base substrate, formed thereon in a matrix shape. Among the plurality of pixels, a ji^{th} pixel Pji includes a j^{th} gate line GLj, an i^{th} data line DLi, a ji^{th} TFT Tji and a ji^{th} pixel electrode PEji.

The j^{th} gate line GLj extends in the first direction D1. The i^{th} data line DLi and the j^{th} gate line GLj are electrically insulated from each other. The i^{th} data line DLi extends in the second direction D2, substantially perpendicular to the first direction D1, and intersects the j^{th} gate line GLj.

A ji^{th} pixel area PAji is defined by the j^{th} data line DLi and j^{th} gate line GLj that are adjacent to i+1^{th} data line DLi+1 and j−1^{th} gate line GLj−1, respectively. The ji^{th} pixel area PAji has the ji^{th} TFT Tji and the ji^{th} pixel electrode PEji formed thereon.

The gate electrode G of the ji^{th} TFT Tji is diverged from the j^{th} gate line GLj, the source electrode S is diverged from the i^{th} data line DLi, and the drain electrode D is electrically connected to the ji^{th} pixel electrode PEji. The data signal is transferred through the i^{th} data line DLi, and the gate signal is applied to the j^{th} gate line GLj. Therefore, the TFT Tji outputs the data signal into the ji^{th} pixel electrode PEji in response to the gate signal.

In addition, the ji^{th} pixel Pji may further include a ji-th storage voltage line SEji that receives a common voltage Vcom and defines a sub capacitor Cst.

The array substrate 210 has the first signal lines SL1 formed thereon and extending to the first direction D1 in parallel with the gate lines GL, and the second signal lines SL2 formed thereon and extending to the second direction D2 in parallel with the data line DL.

The first signal lines SL1 may be formed on the same layer as the gate lines GL, and the second signal lines SL2 may be formed on the same layer as that of the data lines DL to reduce a manufacturing process of the array substrate 210 and a thickness of the display panel 200. The initial driving voltage Vid is provided to the first signal lines SL1 and the second signal lines SL2.

The array substrate 210 includes the first sensing electrodes ES1 formed there on, and the first sensing electrodes ES1 are disposed over the upper portion of the first signal lines SL1 and electrically connected to the first protrusion electrodes ER1 formed on the opposite substrate 220. In addition, the array substrate 210 further includes the second sensing electrodes ES2 formed thereon, and the second sensing electrodes ES2 are disposed on the upper portion of the second signal lines SL2 and electrically connected to the second protrusion electrodes ER2 formed on the opposite substrate 220.

Referring to FIGS. 4 and 5, the array substrate 210 includes a first base substrate 211, a TFT array layer 212, and the pixel electrode PE.

The first base substrate 211 includes a transparent material such as, but not limited to, glass.

The first base substrate 211 has the TFT array layer 212 formed thereon. The TFT array layer includes a plurality of TFTs, a protective layer 213, a planarizing layer 214 and the first signal line SL1.

Each of the plurality of TFTs includes a gate electrode 212a, a gate insulating layer 212b, an active layer 212c, an ohmic contact layer 212d, a source electrode 212f and a drain electrode 212e.

The protective layer 213, or passivation layer, includes, for example, an organic insulating layer, an inorganic insulating layer, or a combination thereof, covering the TFT.

In addition, a contact hole CTH3 is formed on the protective layer 213 and the planarizing layer 214 to expose the drain electrode 212e of the TFT.

Since the first signal line SL1 is formed on the same layer as the gate electrode 212a, the gate insulating layer 212b, the protective layer 213 and the planarizing layer 214 cover the upper portion of the first signal line SL1. Therefore, the first signal line SL1 is electrically insulated from the first protrusion electrode ER1.

The second signal lines SL2 may be formed on the gate insulating layer 212b from a substantially same layer as the source electrodes 212f and the drain electrodes 212e as well as the data lines DL. The protective layer 213 and the planarizing layer 214 cover the second signal lines SL2. Thus, the second signal lines SL2 are electrically insulated from the second protruded electrodes ER2.

The pixel electrode PE includes a transparent conductive material, for example indium tin oxide (“ITO”), and is formed on the planarizing layer 214 corresponding to each pixel area.

The first sensing electrode ES1 for electrical contact between the first signal line SL1 and the first protrusion electrode ER1 is formed through an etching process for forming the pixel electrode PE. Therefore, the first sensing electrode ES1 is formed on an upper portion of the planarizing layer 214, as is the pixel electrode PE.

Likewise, the second sensing electrode ES2 for electrical contact between the second signal line SL2 and the second protrusion electrode ER2 is formed on the planarizing layer 214, in a same layer as the pixel electrode PE.

The gate insulating layer 212b, the protective layer 213 and the planarizing layer 214 have a contact hole CTH1 formed thereon, and the contact hole CTH1 exposes the first signal line SL1, or a branch line BR (shown in FIG. 4) of the first signal line SL1, to electrically connect the first sensing electrode ES1 to the first signal line SL1.

The second sensing electrode ES2 may be electrically connected to the second signal line SL2 through a contact hole CTH2 through which the second signal line SL2 is partially exposed. The contact hole CTH2 for partially exposing the second signal line SL2 may be formed through the protective layer 213 and the planarizing layer 214.

The opposite substrate 220 includes a second base substrate 221, a light-blocking layer (or black matrix) 222, a color filter layer 223, a planarizing layer 224, a protrusion pattern 225, a supporting pattern 226, and a common electrode layer 227.

The second base substrate 221 includes a transparent insulating material such as glass or polycarbonate (“PC”). In one embodiment, the second base substrate 221 is flexible to be bent when an external force PO is applied thereto, so that the display panel 200 has the touch screen function, in which case the second base substrate 221 may include a plastic material substrate such as PC.

Alternatively, a glass substrate may be etched or grinded to have a thin thickness of about 0.2 mm to about 0.5 mm and the glass substrate having a thickness of about 0.2 mm to about 0.5 mm may be employed as the second base substrate 221.

The light-blocking layer 222 of the opposite substrate 220 is formed to face the TFT, the data line DL, the gate line GL, the first signal line SL1 and the second signal line SL2 of the array substrate 210. The light-blocking layer 222 blocks light passing through a liquid crystal which is disposed in an area not controlled by the pixel electrode PE, and enhances a contrast ratio of the display panel.

The color filter layer 223 includes, for example, a red filter pattern R, a green filter pattern G and a blue filter pattern B, and is correspondingly formed to a pixel. For example, the color filter layer 223 partially overlaps the light-blocking layer 222.

The planarizing layer 224 is formed on an upper portion of color filter layer 223, and may be an organic insulating layer planarizing the opposite substrate 220.

The protrusion pattern 225 and the supporting pattern 226 may be formed through a photolithography process. In other words, a photosensitive macromolecule organic material PP is coated on the second base substrate 221 having the light-blocking layer 222 formed thereon, and an exposure mask is disposed over the photosensitive macromolecule organic material. Then, the organic material is exposed and developed.

The protrusion pattern 225 and the supporting pattern 226 are formed to have a different length from each other, based on a different development property according to the amount of exposure or an exposing time. Therefore, the supporting pattern 226 has a first length a1 to maintain a separation distance substantially equal to a cell gap between the array substrate 210 and the opposite substrate 220, and the protrusion pattern 225 has a second length a2 that is smaller than the first length a1 of the supporting pattern 226 to carry out the touch screen function. Thus, the supporting pattern 226 serves as a set of column spacers for the display panel 200.

In addition, the protrusion pattern 225 is formed in plural in regions corresponding to the first signal lines SL1 formed on the array substrate 210. Like wise, the protrusion pattern 225 is formed in plural in regions corresponding to the second signal lines SL2 formed on the array substrate 210.

For example, the supporting pattern 226 is formed in a shading area, not to affect a light transmissivity of the display panel 200 due to the supporting pattern 226. The supporting pattern 226 may be formed on each pixel, or on each unit pixel having a predetermined number of pixels. For example, the supporting pattern 226 is formed with a uniform density.

The common electrode layer 227 includes a transparent conductive material such as indium tin oxide (“ITO”), indium zinc oxide (“IZO”), etc., and is formed on the planarizing layer 224 such that the common electrode layer 227 covers the protrusion pattern 225. During a process of forming the common electrode 227, a transparent conductive layer may also be formed on the top of the supporting pattern 226. Preferably, the transparent conductive layer formed on the top of the supporting pattern 226 is removed. Additionally, the transparent conductive layer covering the remaining portions of the supporting pattern 226 may be removed.

The common electrode layer 227 is formed such that the common electrode layer 227 covers an upper portion of the protrusion pattern 225, so that the first protrusion electrode ER1 including the protrusion pattern 225 and the common electrode layer 227 is completed. Also, it should be understood that the common electrode layer 227 further covers an upper portion of the protrusion pattern 225, so that the second protrusion electrode ER2 including the protrusion pattern 225 and the common electrode layer 227 is completed.

Therefore, as illustrated in FIG. 6, the first protrusion electrode ER1 together with the second base substrate 221 bent by the external force PO, moves toward the array substrate 210, and the first protrusion electrode ER1 is electrically connected to the first sensing electrode ES1. As described above, the potential of the initial driving voltage Vid applied to the signal lines SL varies according to the contact between the protrusion electrode ER and the sensing electrode ES, and thus the coordinate of the external force PO applied thereto can be detected.

The first protrusion electrode ER1 is formed on the light-blocking layer 222. In other words, the first protrusion electrode ER1 and the first sensing electrode ES1 are formed so as not to be overlapped with a transmissive area of the pixels, so that an aperture ratio of the pixels should not be affected.

For this purpose, the first signal line SL1 has a branch line BR connected thereto, and the first protrusion electrode ER1 and the first sensing electrode ES1 may be formed in a light-blocking layer area. The branch line BR is extended along the second direction D2 from the first signal line SL1 extended along the first direction D1, and is formed on the light-blocking layer area.

In addition, to form the first protrusion electrode ER1, the light-blocking layer 222 is preferably formed to have an enough width for covering the first protrusion electrode ER1 between a unit pixel and an adjacent unit pixel. The unit pixel includes, for example, a ji−1^{th} pixel Pji−1, a ji^{th} pixel Pji, a ji+1^{th} pixel Pji+1 each displaying the R, G, B color.

Furthermore, the first sensing electrode ES1 is formed on the same layer as that of a ji+1^{th} pixel electrode PEji+1,and formed to have a separation distance from the ji+1^{th} pixel electrode PEji+1 to prevent a coupling phenomenon between the first sensing electrode ES1 and the ji+1^{th} pixel electrode PEji+1. Therefore, the pixel electrode PEji+1 adjacent to the first sensing electrode ES1 may be formed to have a recessed area toward a ji+1^{th} pixel area PAji+1, so that the pixel electrode PEji+1 has a concave portion when viewed on a plane as shown in FIG. 4.

As described above, the protrusion electrode ER and the signal line SL have been described with respect to the first protrusion ER1 and the first signal line SL1, but it would have been obvious to any person skilled in the art to which it pertains that a second protrusion electrode ER2 and a second signal line SL2 are formed through substantially the same method for forming the first protrusion electrode ER1 and the first signal line SL1.

Furthermore, it has been illustrated in an exemplary embodiment of the present invention that the first and second protrusion electrodes ER1 and ER2, and the first and second sensing electrodes ES1 and ES2 corresponding to the first and second protrusion electrodes ER1 and ER2, respectively are formed in the areas corresponding to the light-blocking layer 222. Alternatively, the first and second protrusion electrodes ER1 and ER2 are adjacent to each other, and the first and second sensing electrodes ES1 and ES2 may be formed in the same light blocking layer area, by adjacently forming the branch line BR of the first signal line SL1 and the second signal line SL2 in the same light-blocking layer 222, and forming the first and second sensing electrodes ES1 and ES2 on an upper portion of the branch line BR and the second signal line SL2, respectively.

Furthermore, in an alternative embodiment, the first and second protrusion electrodes ER1 and ER2 may be integrally formed to form a united protrusion electrode, by adjacently forming the first and second sensing electrodes ES1 and ES2 in the same light-blocking layer 222, and by integrally forming the first and second protrusion pattern 225.

A method of carrying out the touch screen function of the display panel will be described as follows.

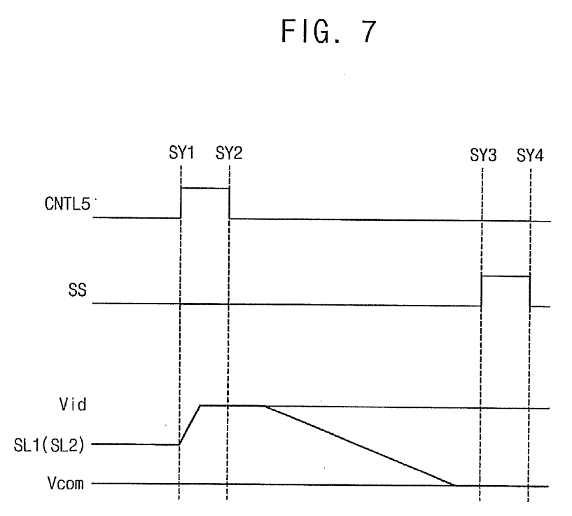

FIG. 7 is a timing chart illustrating an exemplary method for detecting a touch point according to an exemplary embodiment of the present invention, and FIG. 8 is a diagrammatic plan view embodying an exemplary detecting portion for detecting the touch point in FIG. 1 according to the timing chart in FIG. 7.

Referring to FIGS. 7 and 8, a power supply control part 410 is driven in response to the fifth control signal CNTL5 outputted from the timing control part 310 illustrated in FIG. 1, under a condition that the common electrode layer 227 has the common voltage Vcom applied thereto (a period before SY1). Then, the initial driving voltage Vid outputted from the power supply part 320 is applied to the first and second signal lines SL1 and SL2 (during a period between SY1 and SY2).

When predetermined protrusion electrodes ER1p+q and ER2p+q among the first and second protrusion electrodes ER1 and ER2 formed on the first and second signal lines SL1 and SL2, contact the first and second signal lines SL1 and SL2 by the external force (during a period between SY2 and SY3), respectively, a voltage level of the first and second signal lines SL1 and SL2 contacted by the protrusion electrodes ER1p+q and ER2p+q varies.

When a potential of the common voltage Vcom is lower than that of the initial driving voltage Vid, for example when the common voltage Vcom is about 0V and the initial driving voltage Vid is about 5 V, a current transferred by the first and second signal lines SL1 and SL2 is applied to the common electrode layer 227 and the voltage level of the first and second lines SL1 and SL2 approaches or becomes the potential of the common voltage Vcom (during a period between SY3 and SY4).

In this condition, a data sampling part 420 latches the varied voltage level of the first and second signal lines SL1 and SL2 in response to a sampling signal SS provided by the timing control part 310, such as during the period between SY3 and SY4, and generates and outputs the first and second detecting signals DS1 and DS2.

For this purpose, the data sampling part 420 may include a latch receiving the sampling signal SS as a control input.

The data sampling part 420 may be independently formed at each first and second signal lines SL1 and SL2. In addition, the power supply control part 410 may be formed with a switching element such as a metal oxide semiconductor (“MOS”) transistor, etc., and may be commonly connected to both the first and second signal lines SL1 and SL2.

Thereafter, the positioning part 500 illustrated in FIG. 1, combines the Y and X axis coordinates and determines the touch point on the display panel 200 where the external force PO is applied. The Y and X axis coordinates are determined based on the first and second detecting signals DS1 and DS2 outputted by the data sampling part 420.

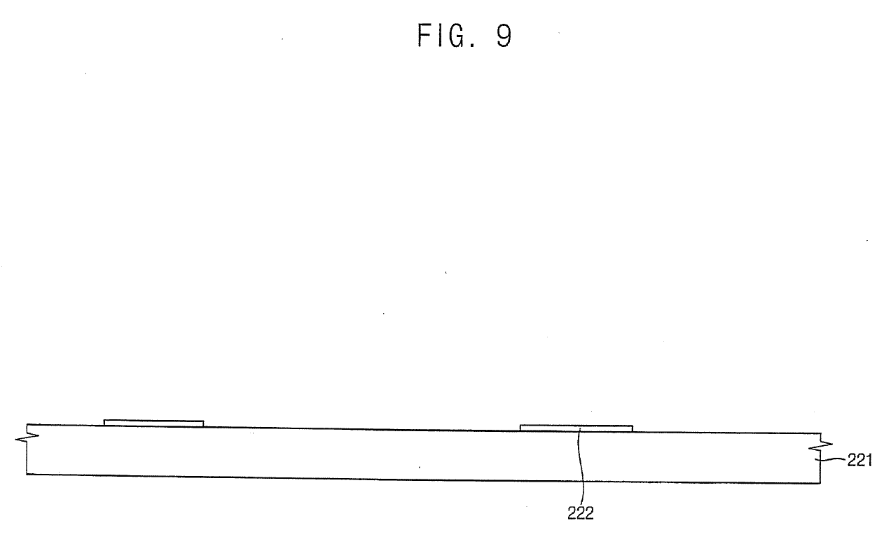

FIGS. 9 to 16 are cross-sectional views illustrating an exemplary manufacturing process for the exemplary display substrate according to an exemplary embodiment of the present invention. Particularly, the opposite substrate 220 having the protrusion pattern 225 and the supporting pattern 226 formed thereon in FIG. 5 is illustrated.

Referring to FIG. 9, each pixel is divided on an upper portion of the second base substrate 221 of the opposite substrate 220, and the light-blocking layer 222 is formed on each pixel so that the light does not flow into each pixel from the exterior. The light-blocking layer 222 may include a metallic thin film such as chromium (Cr) or an organic material such as carbonate. The light-blocking layer 222 may also include a double layer such as chromium (Cr)/chromium oxide (CrOx) to reduce a reflectivity. While particular exemplary materials are described, it should be understood that alternate suitable materials would be within the scope of these embodiments.

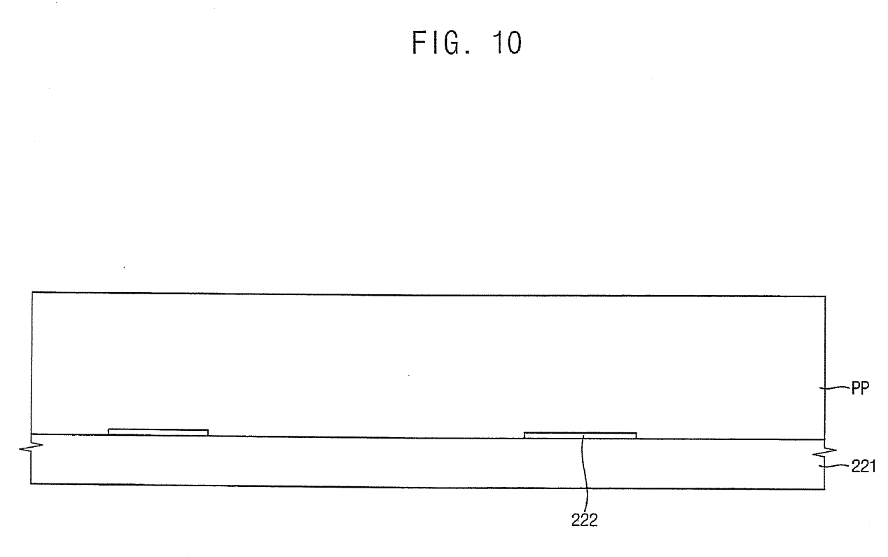

Referring to FIG. 10, the photosensitive macromolecule organic material PP is coated on a total area of the second base substrate 221 having the light-blocking layer 222 formed thereon. The thickness of the photosensitive macromolecule organic material PP is, preferably, the same as the first length a1 of the supporting pattern 226 illustrated in FIG. 5.

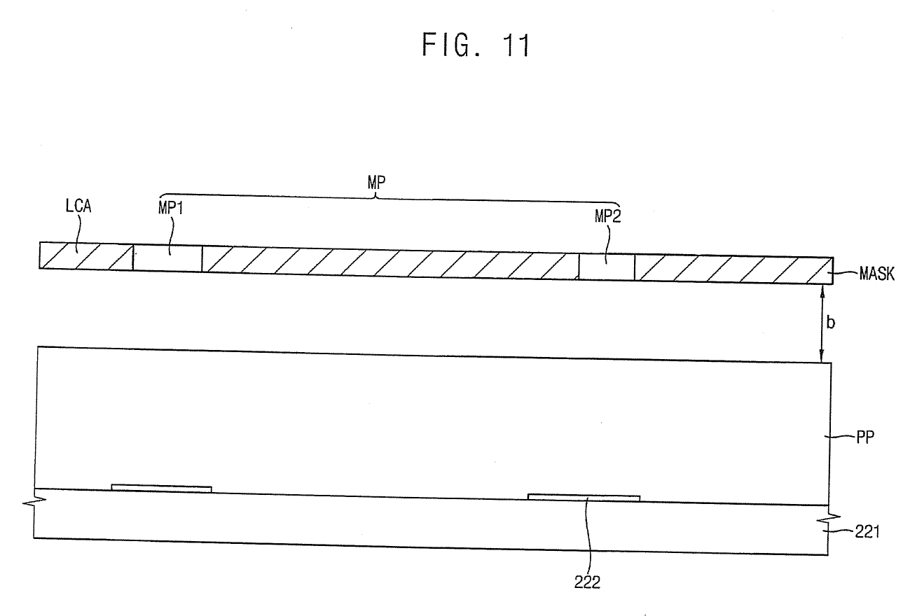

Referring to FIG. 11, an exposure mask MASK is disposed with a predetermined distance b on an upper portion of the photosensitive macromolecule organic material PP. A light source is disposed over the exposure mask MASK, and then exposes the photosensitive macromolecule organic material PP. The exposure mask MASK includes a shading material such as chromium (Cr) to shade the light. In addition, the exposure mask has a first mask pattern MP1 and a second mask pattern MP2 formed thereon, and a light shading area LCA is formed outside of the first and second mask patterns MP1 and MP2.

The first mask pattern MP1 is a mask pattern to form the supporting pattern 226 on the second base substrate 221, and the second mask pattern MP2 is a mask pattern to form the protrusion pattern 225 on the second base substrate 221. In addition, the first mask pattern MP1 has substantially the same peripheral shape as the second mask pattern MP2, but is relatively larger than the second mask pattern MP2. For example, when the first and second mask patterns MP1 and MP2 have a circular shape, a diameter of the first mask pattern MP1 is longer than a diameter of the second mask pattern MP2.

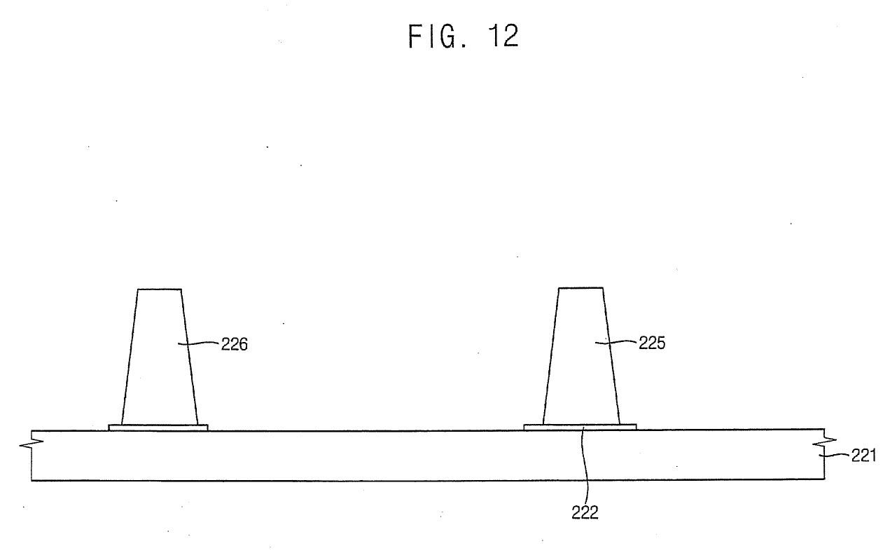

Referring to FIG. 12, when the photosensitivity macromolecule organic material PP is exposed by a proximity type exposure process using the exposure mask MASK, the photosensitivity macromolecule organic material PP in an area corresponding to the first and second mask patterns MP1 and MP2 is exposed but the photosensitivity macromolecule organic material PP in an area corresponding to the light shading area LCA is not exposed.

According to a size of the first and second mask patterns MP1 and MP2, a diffraction of the light changes, and thus an exposed area varies. In other words, the first mask pattern MP1 having a relatively larger size than the second mask pattern MP2, has a smaller diffraction quantity. Therefore, the photosensitivity macromolecule organic material PP in an area corresponding to the first mask pattern MP1 is exposed much more than the photosensitivity macromolecule organic material PP in an area corresponding to the second mask pattern MP2.

A baking process and a developing process are performed on the photosensitivity macromolecule organic material PP having a different exposure quantity. Then, the photosensitivity macromolecule organic material PP corresponding to the light shading area LCA is eliminated. Therefore, according to the different exposure quantity, the supporting pattern 226 almost maintaining an initial coated thickness of the photosensitivity macromolecule organic material PP and having the first length a1, is formed on a lower portion of the first mask pattern MP1.

In addition, according to the different exposure quantity, the protrusion pattern 225 eliminated with a predetermined thickness from the initial coated thickness of the photosensitivity macromolecule organic material PP and having the second length a2, is formed on a lower portion of the second mask pattern MP2.

A separation distance b between the photosensitivity macromolecule organic material PP and the exposure mask MASK may control the first length a1 of the supporting pattern 226 and the second length a2 of the protrusion pattern 225. In other words, in the proximity type exposure process, since the exposure process is performed by equipment controlling the separation distance b, the length of the supporting pattern 226 and the protrusion pattern 225 can be controlled. That is, a principle that an incident angle having 90° decreases and thus the exposure quantity decreases when the separation distance b increases, and the incident angle having 90° increases and thus the exposure quantity increases when the separation distance b decreases, is used for controlling the exposure quantity of the photosensitivity macromolecule organic material PP.

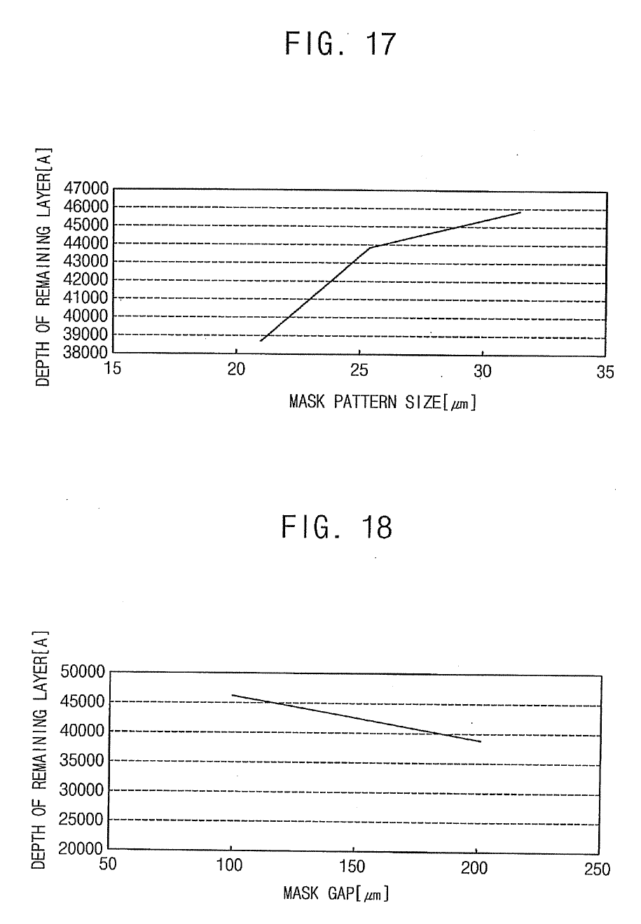

As illustrated in FIG. 17, the exposure and developing process are performed using the mask patterns MP1 and MP2 formed at the exposure mask MASK, and then a remaining thickness of the photosensitivity macromolecule organic material PP is decided in proportion to the size of the mask patterns MP1 and MP2. In addition, as illustrated in FIG. 18, a remaining thickness of the photosensitivity macromolecule organic material PP is decided in inverse proportion to the separation distance b between the exposure mask MASK and the photosensitivity macromolecule organic material PP.

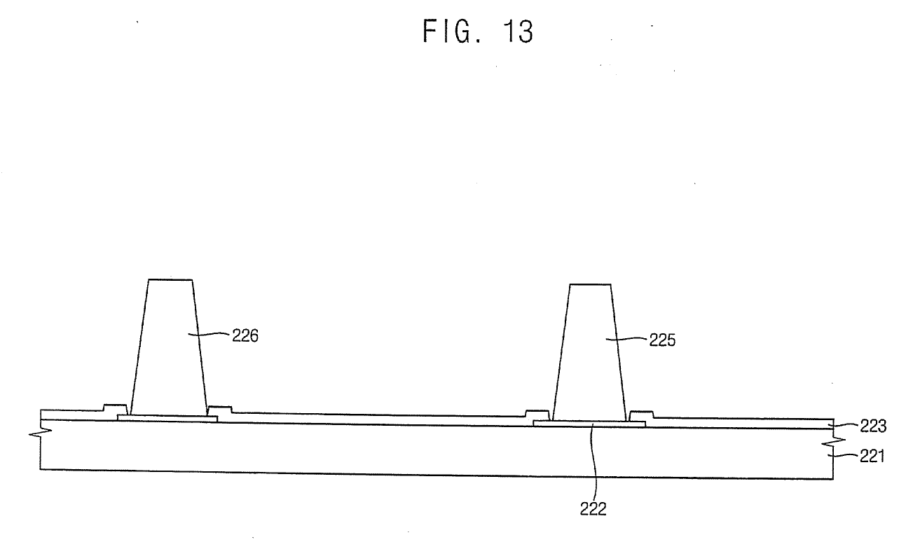

Referring to FIG. 13, the color filter layer 223 is formed on the upper portion of the second base substrate 221 having the supporting pattern 226 and the protrusion pattern 225 formed thereon. The color filter layer 223 is formed on a position where color filter patterns of R, G and B, for example, correspond to the pixel unit along the light-blocking layer 222.

The color filter layer 223 is formed by, for example, a spin coating process for a uniform thickness. In the spin coating process, a pigment forming the color filter is spouted from a lower portion as compared to the upper portion of the supporting pattern 226 and the protrusion pattern 225, and thus the color filter layer 223 is not formed on the upper portion of the supporting pattern 226 and the protrusion pattern 225.

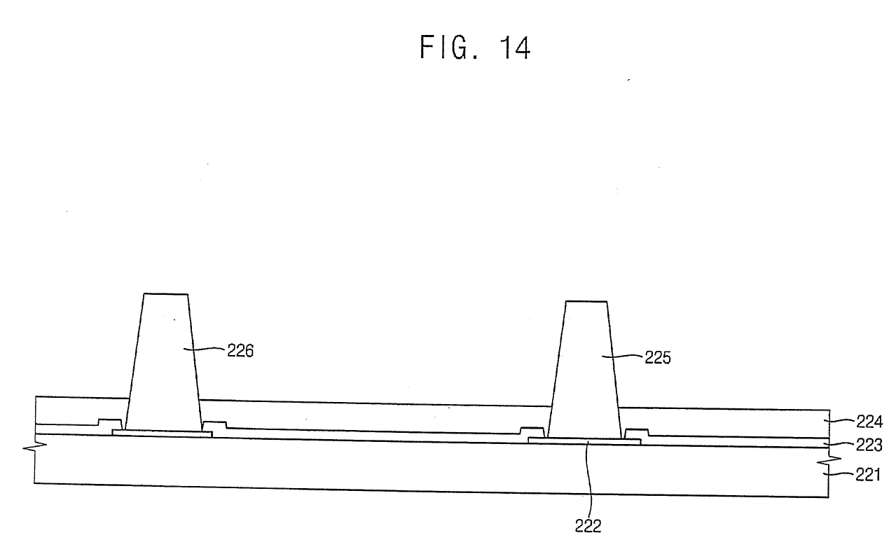

Referring to FIG. 14, the planarizing layer 224 is formed on the upper portion of the second base substrate 221 having the color filter layer 223 formed thereon. The planarizing layer 224 protects the color filter layer 223 and planarizes the opposite substrate 220. The planarizing layer 224 may include acryl or polyimide resin.

Referring to FIG. 15, the common electrode layer 227 is formed on the upper portion of the second base substrate 221 having the planarizing layer 224 formed thereon. The common electrode layer 227 is coated on the planarizing layer 224 as well as on the protrusion pattern 225 and the supporting pattern 226. The common electrode layer 227, for applying the common voltage Vcom to the liquid crystal material, is formed by sputtering and depositing a transparent conductive material, such as ITO, having a high transmissivity, conductivity, chemical safety and thermal safety. The protrusion pattern 225 and the common electrode layer 227 forms the protrusion electrode ER and the protrusion electrode ER electrically contacts to the signal lines SL illustrated in FIG. 5 by the external force PO. The electric contact changes the voltage level of the initial driving voltage Vid as described with respect to FIG. 7, and thus the coordinate of the external force PO applied thereto may be detected.

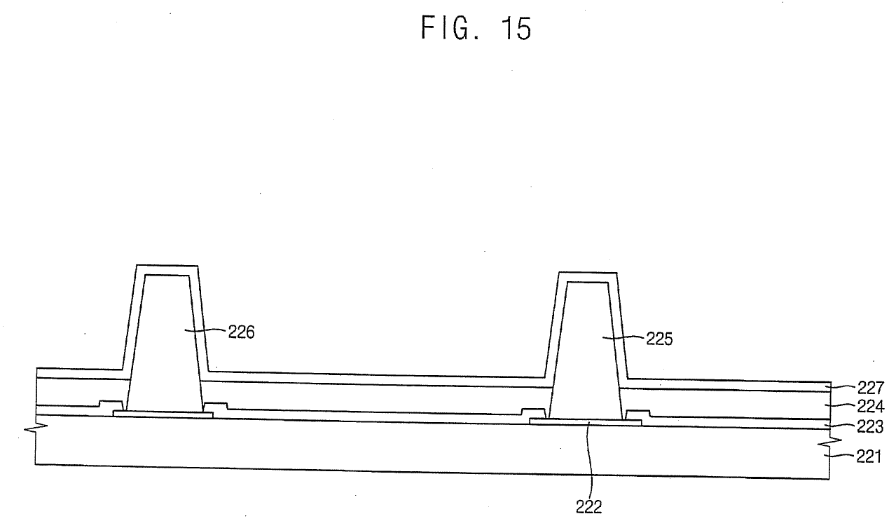

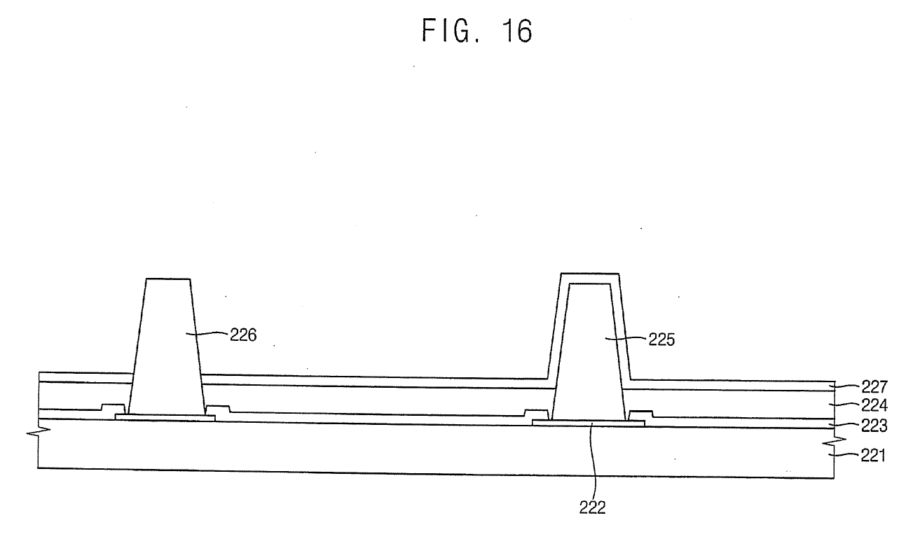

Referring to FIG. 16, he common electrode layer 227 is eliminated by an additional process from the supporting pattern 226 and a nonconductive supporting pattern 226 is formed. Therefore, the common voltage Vcom applied to the common electrode layer 227 is prevented from changing due to the electrical connection to the array substrate 210 illustrated in FIG. 5, and so that an electrical effect on elements formed on the array substrate 210 due to the common voltage Vcom does not exist.

In this exemplary embodiment, while a negative type exposure process that the photosensitivity macromolecule organic material PP is remained by the developing process, has been described, it should be understood that a positive type exposure process can also be applicable in an alternative embodiment.

As previously referenced, FIG. 17 is a graph showing a relation between a size of a mask pattern formed on an exemplary exposure mask and a thickness of a remaining layer after an exemplary developing process. Referring to FIG. 17, it can be seen that the larger size the mask pattern has, the thicker thickness does the remaining layer after the developing process has.

FIG. 18 is a graph illustrating a variation of the thickness of the remaining layer after the exemplary developing process according to a separation distance between the exemplary exposure mask and a photosensitivity macromolecule organic material. Referring to FIG. 18, it can be seen that the larger the separation distance between the mask and the photosensitivity macromolecule organic material PP, the thicker the thickness of the remaining layer after the developing process.

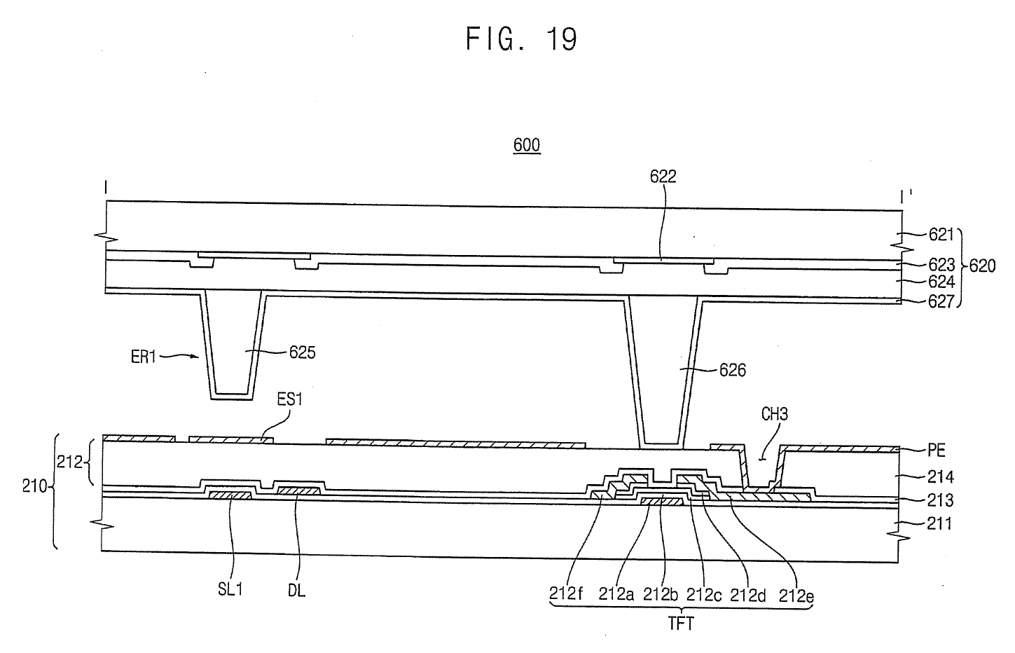

FIG. 19 is a partial cross-sectional view taken along line I-I′ of FIG. 4 and illustrating the exemplary display panel according to another exemplary embodiment of the present invention.

Referring to FIG. 19, a display panel 600 includes an array substrate 210, an opposite substrate 620, and a liquid crystal layer (not shown) disposed between the array substrate 210 and the opposite substrate 620.

Referring to FIGS. 5 and 19, the display panel 600 of FIG. 19 includes the same structural array substrate 210 as the display panel 200 of FIG. 5. Therefore, a specific description on the array substrate 210 illustrated in FIG. 19 will be omitted.

The opposite substrate 620 includes a base substrate 621, a black matrix 622, a color filter layer 623, a planarizing layer 624, a protrusion pattern 625, a supporting pattern 626, and a common electrode layer 627. The base substrate 621, the black matrix 622, and the color filter layer 623 may be formed with the same structure as the opposite substrate 220 of the display panel 200 according to the exemplary embodiment of the present invention. Therefore, any further explanation of these elements will be omitted.

The planarizing layer 624 is formed on the color filter layer 623 and includes an organic insulating layer planarizing the opposite substrate 620.

The protrusion pattern 625 and the supporting pattern 626 may be formed by a photolithography process including coating the photosensitivity macromolecule organic material PP on the planarizing layer 624, disposing the mask on an upper portion of the photosensitivity macromolecule organic material PP and exposing the mask. The protrusion pattern 625 and the supporting pattern 626 may be formed within the same positions as the protrusion pattern 225 and the supporting pattern 226 formed on the display panel 200 according to the exemplary embodiment of the present invention.

The protrusion pattern 625 is formed on the base substrate 621. The protrusion pattern 625 protrudes toward the direction of the array substrate 210 with a predetermined protrusion height. The protrusion height of the protrusion pattern 625 is formed to be less than a cell gap between the array substrate 210 and the opposite substrate 620.

The supporting pattern 626 is simultaneously formed with the protrusion pattern 625, and has a larger diameter than the protrusion pattern 625. In addition, the supporting pattern 626 is formed with a same height as the cell gap between the array substrate 210 and the opposite substrate 620. Therefore, the supporting pattern 626 maintains the separation distance between the array substrate 210 and the opposite substrate 620 and supports the array substrate 210 and the opposite substrate 620.

Preferably, the supporting pattern 626 is formed over the black matrix, so as not to affect a light transmissivity of the display panel 600. In addition, since the common electrode layer 627 is formed on the supporting pattern 626, the supporting pattern 626 is preferably formed in a black matrix area in which the supporting pattern 626 does not electrically contact the pixel electrode PE formed on the array substrate 210 or the first sensing electrode ES1. The supporting pattern 626 may be formed on each pixel, or on each unit pixel having a predetermined number of pixels. Preferably, the supporting pattern 626 is formed with a uniform density in an entire display panel 600.

The common electrode layer 627 includes transparent conductive material such as indium tin oxide (“ITO”), indium zinc oxide (“IZO”), etc., and is formed on a front surface of the base substrate 621 to cover the protrusion pattern 625 and the supporting pattern 626. A first protrusion electrode ER1 protruded from the base substrate 621 to the direction of the array substrate 210, is formed by the protrusion pattern 625 and the common electrode layer 627 formed on an upper portion of the protrusion pattern 625.

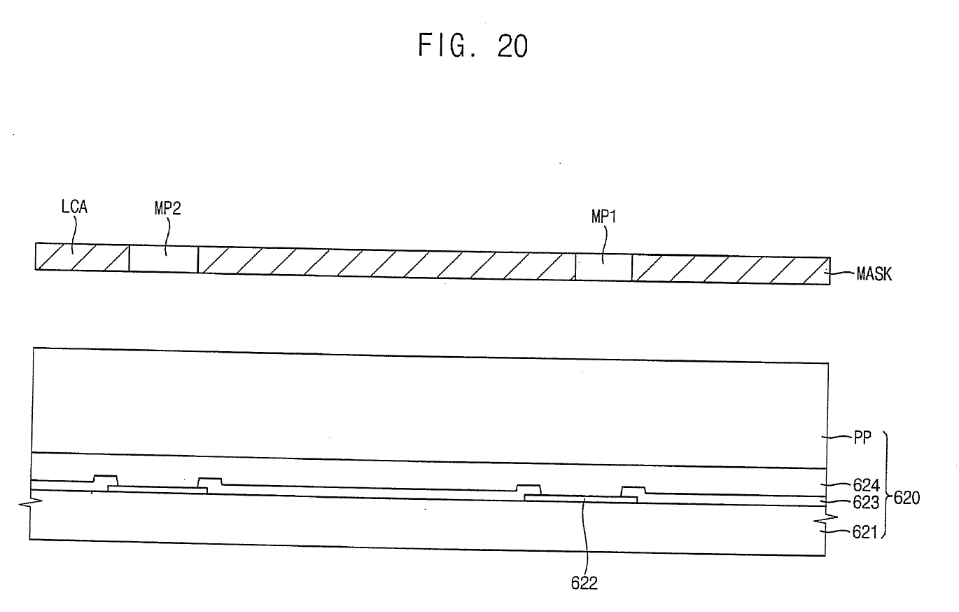

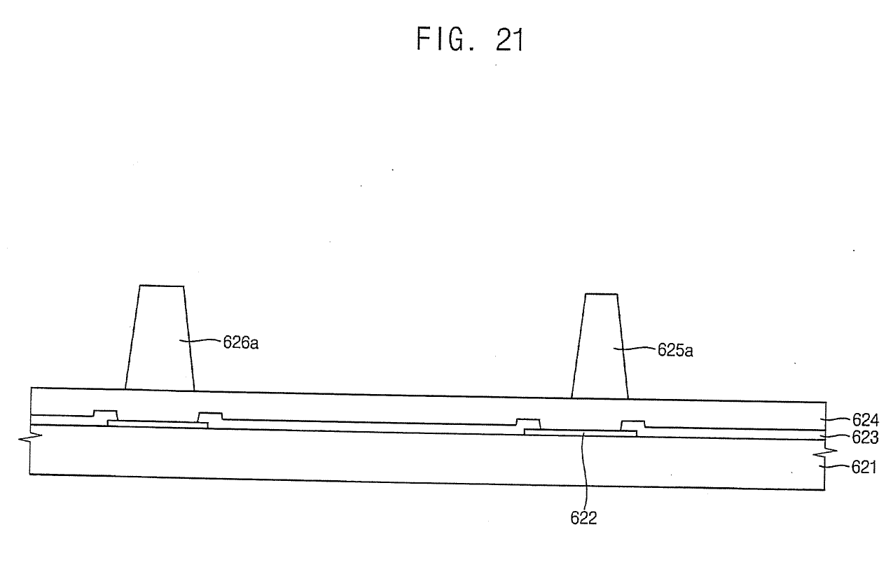

FIGS. 20 and 21 are cross-sectional views illustrating an exemplary manufacturing process of the exemplary protrusion pattern and the exemplary supporting pattern in FIG. 19.

Referring to FIG. 20, the planarizing layer 624 of the opposite substrate 620 has a uniform thickness of photosensitivity macromolecule organic material PP formed thereon. The exposure mask MASK to expose the photosensitivity macromolecule organic material PP is disposed over the photosensitivity macromolecule organic material PP. The exposure mask MASK includes a shading material.

The exposure mask MASK includes the first mask pattern MP1 and the second mask pattern MP2. The diameter of the second mask pattern MP2 is larger than that of the first mask pattern MP1. The light shading area LCA is formed outside of the first and second mask patterns MP1 and MP2.

When the photosensitivity macromolecule organic material PP is exposed, the photosensitivity macromolecule organic material PP in an area corresponding to the first and second mask patterns MP1 and MP2 is exposed but the photosensitivity macromolecule organic material PP in an area corresponding to the light shading area LCA is not exposed.

Referring to FIGS. 20 and 21, when the exposed photosensitivity macromolecule organic material PP is developed, the unexposed photosensitivity macromolecule organic material PP is eliminated and a protrusion pattern portion 625a and a supporting pattern portion 626a both having a column spacer shape are formed on the base substrate 621. The protrusion pattern portion 625a is exposed by the first mask pattern MP1 and is formed. The protrusion pattern portion 626a is exposed by the second mask pattern MP2 and is formed.

The protrusion pattern portion 626a and the supporting pattern portion 625a and 626a have a same height. The supporting pattern portion 626a has a wider diameter than the protrusion pattern portion 625a. For example, the diameter of the protrusion pattern portion 625a may be about 10 μm, and the diameter of the supporting pattern portion 626a may be about 17 μm.

Both surface sides of the protrusion pattern portion 625a and the supporting pattern portion 626a may have step-shapes having decreasing diameters along a direction to the direction of the array substrate. An edge portion contacting the array substrate may have a round shape.

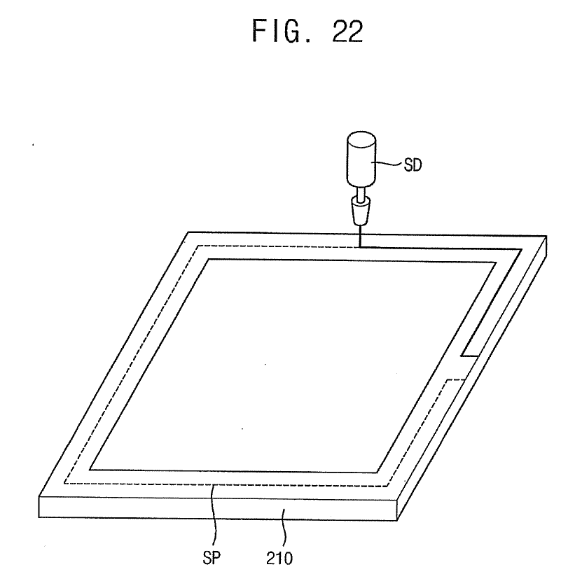

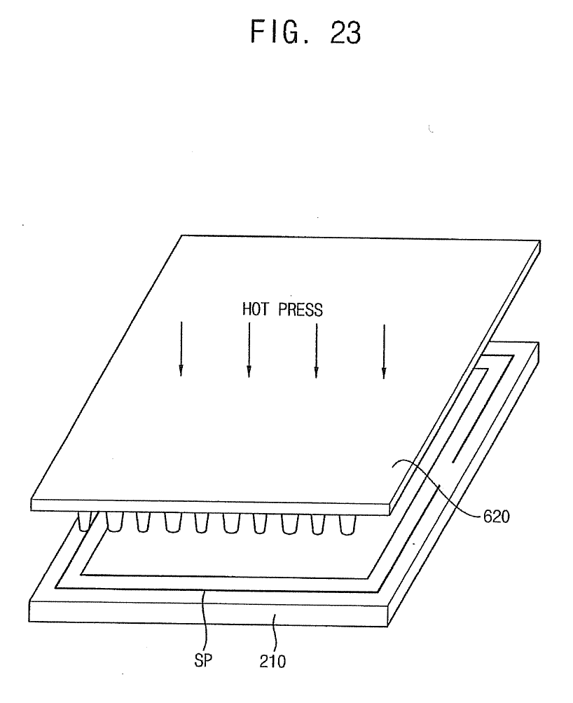

FIGS. 22 and 23 are process diagrams illustrating an exemplary assembly process of the exemplary display panel.

Referring to FIG. 22, a sealant is spread around the edge of the array substrate 210 by a sealant dispenser SD, and a seal pattern SP is formed adjacent the periphery of the array substrate 210. The sealant, for example, includes thermosetting resin, and a width and a height of the seal pattern SP may be substantially uniform.

Then, referring to FIG. 23, the array substrate 210 and the opposite substrate 620 are arranged to face each other, and then the sealant in the seal pattern SP is hardened through a hot press process. Through the hot press process, the array substrate 210 and the opposite substrate 620 are combined with each other having a uniform distance, and the protrusion pattern portion 625a and the supporting pattern portion 626a formed in the opposite substrate 620 are deformed by the external force of the hot press process.

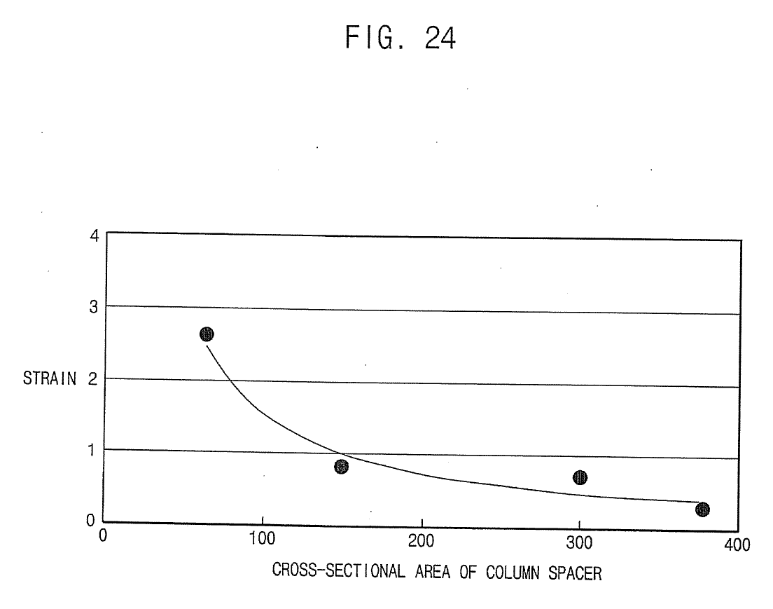

FIG. 24 is a graph illustrating a variation of strains according to a sectional area of the exemplary supporting pattern when a constant external force is applied thereto.

Referring to FIG. 24, it can be found out that the strain with the constant external force decreases when a cross-sectional area of the supporting pattern (column spacer) increases, and the strain increases when the cross-sectional area of the supporting pattern (column spacer) decreases.

Therefore, in the hot press process pressing the array substrate and the opposite substrate together, the protrusion pattern portion having a smaller diameter than the supporting pattern portion has a higher compression strain ratio.

Table 1 shows a cell gap of liquid crystal after applying the same external force to the display panel having different supporting patterns.

TABLE 1

| | Sample 1 | Sample 2 |
|---|---|---|
| Cell gap after applying the external force [μm] | 3.27 | 3.35 |

Sample 1 includes display panels having a 10 μm diameter of the supporting pattern, and Sample 2 includes display panels having a 17 μm diameter of the supporting pattern. The height of the supporting patterns and the cell gap before applying the external force are the same in Sample 1 and Sample 2.

Considering results in Table 1, Sample 1 has an average cell gap of about is 3.27 μm and Sample 2 about 3.35 μm. In other words, the cell gap of liquid crystal in the supporting pattern having the smaller diameter, Sample 1, is smaller than that of in Sample 2. Therefore, it can be noted that the compression strain ratio increases in accordance with decreasing the diameter of the supporting pattern.

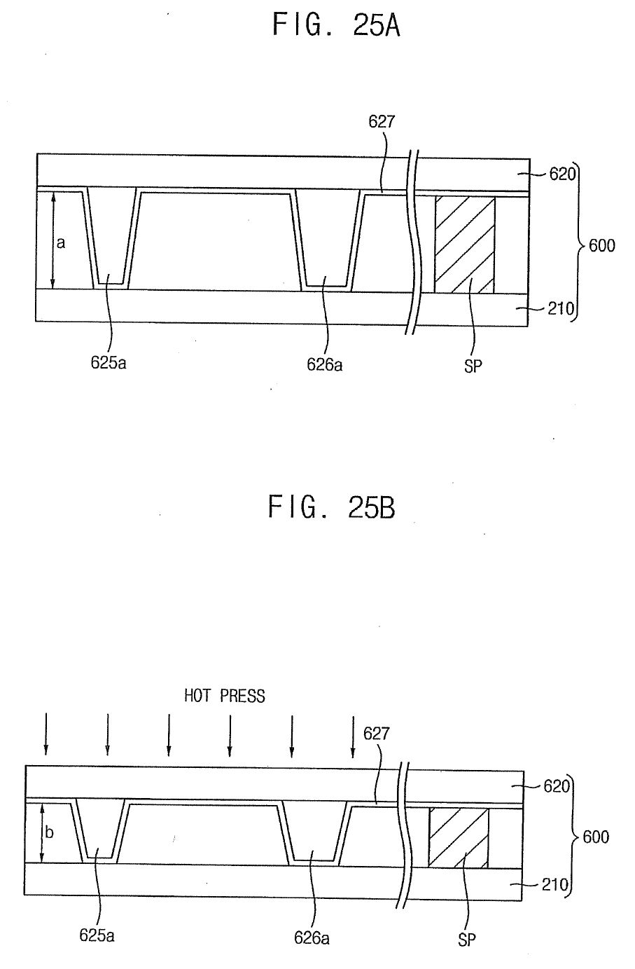

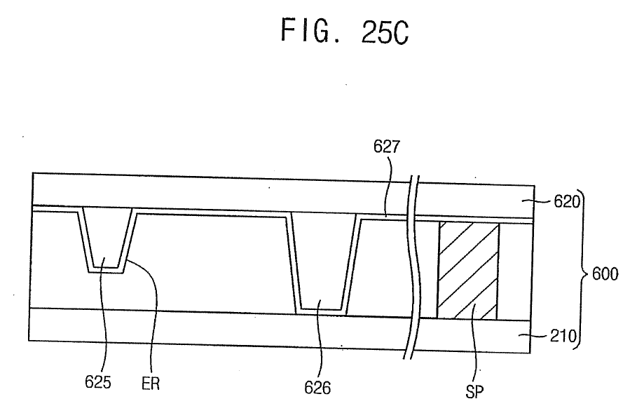

FIGS. 25A to 25C are conceptual diagrams illustrating an exemplary strain 20 process of the exemplary protrusion pattern and the exemplary supporting pattern.

FIG. 25A is a cross-sectional view illustrating a display panel 600 before performing the hot press process, FIG. 25B is a cross-sectional view illustrating a display panel 600 during performing the hot press process, and FIG. 25C is a cross-sectional view illustrating a display panel 600 after performing the hot press process.

Referring to FIGS. 25A and 25B, the protrusion pattern portion 625a and the supporting pattern portion 626a before performing the hot press process after forming the seal pattern SP, has a same first height a. During the hot press process, the protrusion pattern portion 625a and the supporting pattern portion 626a has a same second height b due to the external force of the hot press process, where a>b.

Referring to FIGS. 25B and 25C, since the protrusion pattern portion 625a has a smaller diameter and a higher compression strain ratio as compared to the supporting pattern portion 626a, the height of the protrusion pattern portion 625a is not retrieved after the hot press process. However, since the supporting pattern portion 626a has a larger diameter and a smaller compression strain ratio as compared to the protrusion pattern portion 625a, the height of the supporting pattern portion 626a is almost retrieved to the first height a.

Therefore, a height difference between the protrusion pattern portion 625a and the supporting protrusion pattern portion 626a occurs, with the height of the supporting protrusion pattern portion 626a being greater than the height of the protrusion pattern portion 625a.

Thus, the protrusion pattern portion 625a becomes the protrusion pattern 625 having enough height to contact the array substrate during application of the external force PO. The protrusion pattern 625 becomes the protrusion electrode ER having the touch screen function by the common electrode layer 627 formed on the whole surface of the opposite substrate including covering the protrusion pattern 625.

Since the supporting pattern portion 626a experiences little change in height due to a lower compression strain ratio, the supporting pattern portion 626a becomes the supporting pattern 626 maintaining the separation distance between the array substrate 210 and the opposite substrate 620.

The protrusion pattern 625 and the supporting pattern 626 having different functions may be formed simultaneously through the hot press process of the array substrate 210 and the opposite substrate 620.

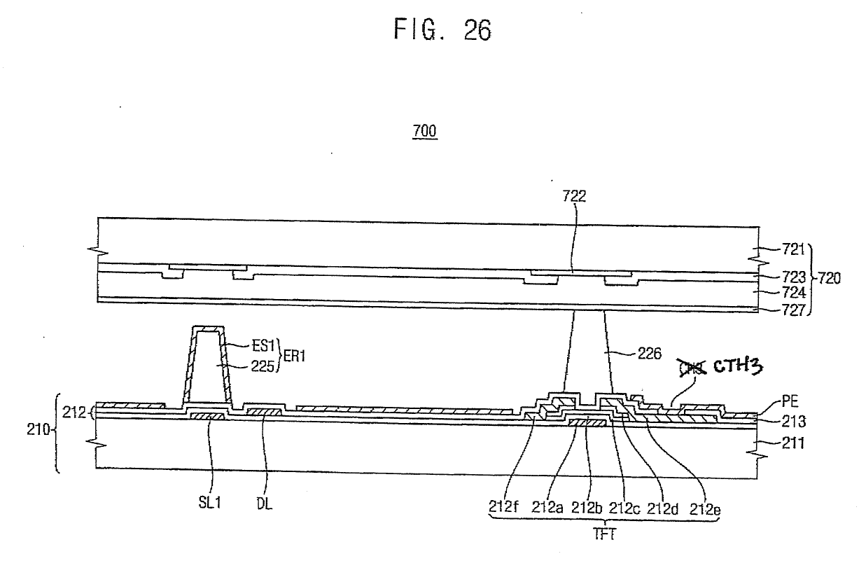

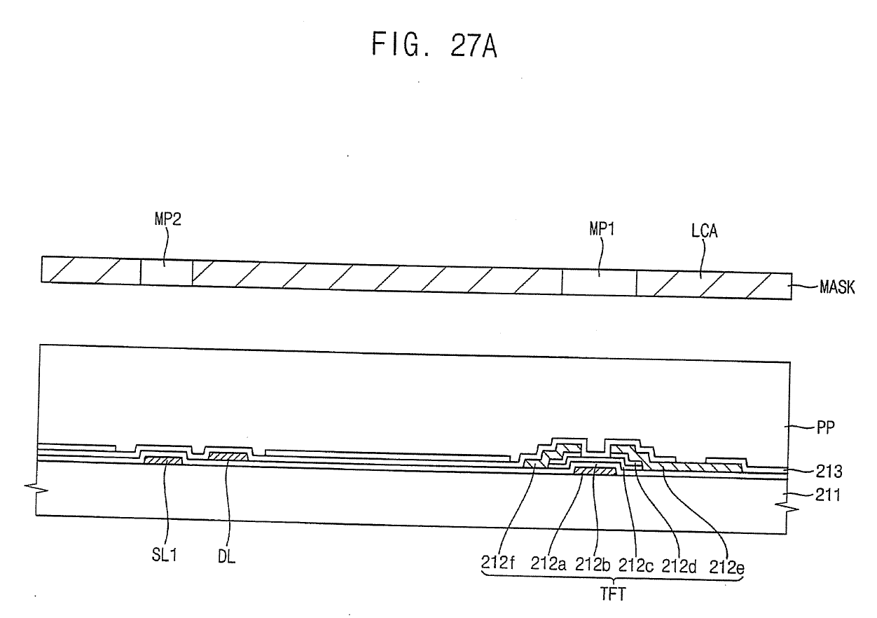

FIG. 26 is a partial cross-sectional view taken along line I-I′ of FIG. 4 and illustrating the exemplary display panel according to still another exemplary embodiment of the present invention.

Referring to FIG. 26, a display panel 700 includes the array substrate 210, an opposite substrate 720, and a liquid crystal layer (not shown) disposed between the array substrate 210 and the opposite substrate 720.

Referring to FIGS. 5 and 26, the display panel 700 according to the present exemplary embodiment of the present invention, may include substantially the same array substrate as the display panel 200 according to the exemplary embodiment of the present invention in FIG. 5. Thus, the same reference numerals will be used to refer to the same or like parts as those described in the exemplary embodiment in FIG. 5.

The array substrate 210 includes the first base substrate 211, the TFT array layer 212, the first protrusion electrode ER1, the supporting pattern 226, and the pixel electrode PE. Although not illustrated, it should be understood that the array substrate 210 further includes the second protrusion electrode ER2.

The first base substrate 211 includes a transparent material such as a glass.

The TFT array layer 212 is formed on the first base substrate 211. The TFT array layer 212 includes the plurality of TFTs, the protective layer 213, and the first signal line SL1. Although not illustrated, it should be understood that the TFT array layer 212 further includes the second signal line SL2.

Each of the plurality of TFTs includes the gate electrode 212a, the gate insulating layer 212b, the active layer 212c, the ohmic contact layer 212d, the source electrode 212f and the drain electrode 212e.

The protective layer 213 includes, for example, the organic insulating layer covering the TFT.

In addition, the contact hole CTH3 is formed through the protective layer 213 in order to expose the drain electrode 212e of the TFT. The protective layer 213 may further include the planarizing layer to planarize the array substrate 210.

Since the first signal line SL1 is formed on the same layer as the gate electrode 212a, the gate insulating layer 212b and the protective layer 213 cover the upper portion of the first signal line SL1.

The TFT array layer 212 has the protrusion pattern 225 and the supporting pattern 226 formed thereon.

The protrusion pattern 225 and the supporting pattern 226 are formed using substantially the same photolithography process described in FIGS. 20 and 21, but in this exemplary embodiment, the protrusion pattern 225 and the supporting pattern 226 are formed on the array substrate 210. In other words, the photosensitivity macromolecule organic material PP is coated on the array substrate 210 having the protective layer 213 formed thereon, the photolithography process using the exposure mask is performed, and then the protrusion pattern 225 and the supporting pattern 226 are formed. A plurality of protrusion patterns 225 is formed corresponding to the first signal lines SL1, and a plurality of protrusion patterns 225 is formed corresponding to the second signal lines SL2 (not shown).

The protrusion pattern 225 is protruded toward the direction of the opposite substrate 720 from the array substrate 210 with a predetermined protrusion height. The protrusion height of the protrusion pattern 225 is formed lower than a cell gap between the array substrate 210 and the opposite substrate 720.

The supporting pattern 226 is simultaneously formed with the protrusion pattern 225, and has a larger diameter than the protrusion pattern 225. In addition, the supporting pattern 226 is formed with the same height as the cell gap between the array substrate 210 and the opposite substrate 720. Therefore, the supporting pattern 226 disposes the array substrate 210 in the separation distance from the opposite substrate 720 and supports the array substrate 210 and the opposite substrate 720.

Preferably, the supporting pattern 226 is formed under a black matrix 722, so as not to affect a light transmissivity of the display panel 700 due to the shape of the supporting pattern 226.

The supporting pattern 226 may be formed on each pixel, or on each unit pixel having a predetermined number of pixels. Preferably, the supporting pattern 226 is formed with a uniform density within the entire display panel 700.

The pixel electrode layer PE includes a transparent conductive material such as indium tin oxide (“ITO”), and is formed on the protective layer 213 corresponding to each pixel.

In the photolithography process forming the pixel electrode layer PE, the first sensing electrode ES1 is formed on the protrusion pattern 225. The first sensing electrode ES1 electrically connects the first signal line SL1 to a common electrode 727 formed in the opposite substrate 720 upon application of an external force PO.

The first sensing electrode ES1 includes the same material as the pixel electrode PE and is formed on the same layer as the pixel electrode PE. The second sensing electrode ES2 (not shown) may also be formed on the same layer as the pixel electrode PE.

The first protrusion electrode ER1 is protruded toward the direction of the opposite substrate 720 from the array substrate 210, by the protrusion pattern 225 and the first sensing electrode ES1 formed on an upper surface of the protrusion pattern 225.

The gate insulating layer 212b and the protective layer 213 have a contact hole CTH1 (not shown) formed there through, and the contact hole CTH1 exposes the first signal lines SL1 to electrically connect the first sensing electrodes ES1 to the first signal lines SL1.

The opposite substrate 720 includes a base substrate 721, the black matrix 722, a color filter layer 723, a planarizing layer 724, and the common electrode layer 727.

The base substrate 721 includes a transparent insulating material such as glass or polycarbonate (“PC”). The base substrate 721 should be bendable upon application of the small external force to endow the display panel 200 with the touch screen function, so the base substrate 721 may include the plastic material substrate such as polycarbonate (“PC”).

The black matrix 722 is formed corresponding to the TFT, the data line DL, the gate line (not shown), the first signal line SL1 and the second signal line (not shown).

The color filter layer 723, for example, includes a red filter pattern, a green filter pattern and a blue filter pattern, and is formed corresponding to the pixels. The color filter layer 723 preferably overlaps a small portion of the black matrix 722.

The planarizing layer 724 is formed on an upper portion of the color filter layer 723 and the exposed portions of the black matrix 722, and includes an organic insulating layer planarizing the second substrate 120.

The common electrode layer 727 includes a transparent conductive material, such as indium tin oxide (“ITO”) or indium zinc oxide (“IZO”), and is formed on the planarizing layer 724.

While the first protrusion electrode ER1 and the first signal line SL1 have been described it should be understood that a second protrusion electrode ER2 and a second signal line SL2 illustrated in FIG. 4 may also be formed with substantially the same method.

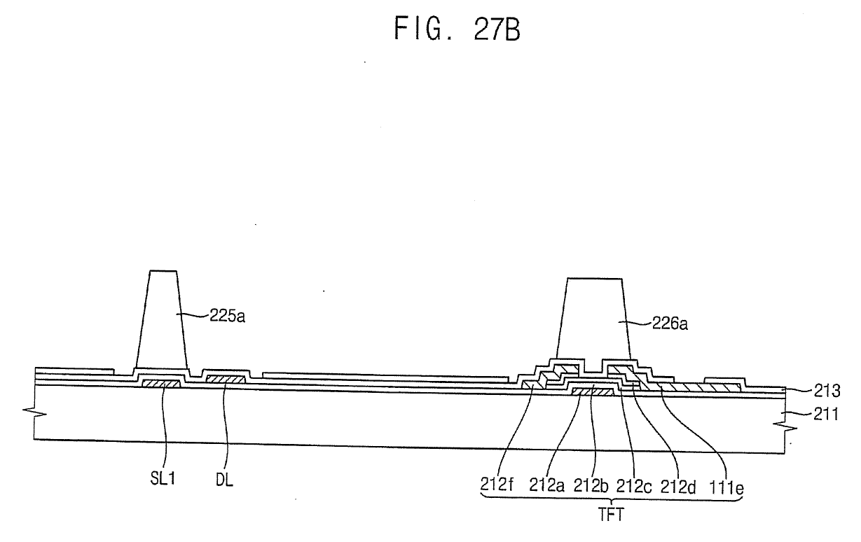

FIGS. 27A and 27B are cross-sectional views illustrating the exemplary manufacturing process of the exemplary protrusion pattern and the exemplary supporting pattern in FIG. 26.

Referring to FIG. 27A, the photosensitivity macromolecule organic material PP is formed with a uniform thickness on the protective layer 213 of the array substrate 210. An exposure mask MASK is disposed over the photosensitivity macromolecule organic material PP to pattern the photosensitivity macromolecule organic material PP. The exposure mask MASK includes a shading material to shade the light.

In addition, the exposure mask MASK has a first mask pattern MP1 and a second mask pattern MP2 formed thereon, and a light shading area LCA is formed outside of the first and second mask patterns MP1 and MP2.

The first mask pattern MP1 is a mask pattern to form the supporting pattern 226 on the array substrate 210, and the second mask pattern MP2 is to form the protrusion pattern 225 on the array substrate 210. In addition, the first mask pattern MP1 has substantially the same shape as the second mask pattern MP2, and has a relatively larger size than the second mask pattern MP2. For example, when the first and second mask patterns MP1, MP2 are formed with a circular shape, a diameter of the first mask pattern MP1 is longer than that of the second mask pattern MP2.

When the photosensitivity macromolecule organic material PP is exposed, an upper surface of the photosensitivity macromolecule organic material PP corresponding to the first and second mask patterns MP1 and MP2 is fully exposed, but the photosensitivity macromolecule organic material PP corresponding to the light shading area LCA is not exposed.

As illustrated in FIG. 27B, when the exposed photosensitivity macromolecule organic material PP is developed, the unexposed photosensitivity macromolecule organic material PP is eliminated. Therefore, the protective layer 213 has a protrusion pattern portion 225a and a supporting pattern portion 226a both having the column spacer shape formed thereon. The protrusion pattern portion and the supporting pattern portion 225a, 226a have a same height. The supporting pattern is portion 226a has a wider diameter than the protrusion pattern portion 225a. For example, the diameter of the protrusion pattern portion 225a may be about 10 μm, and the diameter of the supporting pattern portion 226a may be about 17 μm.

Although not shown in the figure, by a photolithography process, a pixel electrode PE corresponding to each pixel portion and a first sensing electrode ES1 corresponding to the protrusion pattern portion 225, are formed on the protective layer 213 having the protrusion pattern portion 225a and the supporting pattern portion 226a formed thereon. Then, the array substrate 210 and the opposite substrate 720 are thermally compressed using the assembly process described in FIGS. 22 and 23.

The protrusion pattern portion 225a and the supporting pattern portion 226a formed on the array substrate are deformed by the external force in the assembly process described in FIGS. 22 and 23. In this occasion, as described in FIG. 24 and Table 1, since the protrusion pattern portion 225a having a lower diameter has the higher compression strain ratio, a strain of the protrusion pattern portion 225a is larger than that of the supporting pattern portion 226a.

Therefore, referring FIGS. 26 and 27B, the protrusion pattern portion 225a becomes the protrusion pattern 225 having enough height to contact the opposite substrate 720 when the opposite substrate is bent by the external force PO applied to the display panel 700. The protrusion pattern 225 becomes the first protrusion electrode ER1 having the touch screen function by the first sensing electrode ES1 formed on the upper portion of the protrusion pattern 225.

Since the supporting pattern portion 226a has the lower compression strain ratio and experiences little change in height during the assembly process, the supporting pattern portion 226a becomes the supporting pattern 226 disposing the array substrate 210 in the separation distance from the opposite substrate 720.

According to the present invention, the opposite substrate of the display panel is electrically connected to the array substrate having the first and second signal lines to detect the touch point and has the touch function determining the positional coordinate of the touch point. In this occasion, the total process for manufacturing the display substrate can be reduced by forming the protrusion pattern and a supporting member in one process. The protrusion pattern is electrically connected to the first and second signal lines and detects the positional coordinate of the touch point. The supporting member maintains the separation distance between the array substrate and the opposite substrate.

Therefore, the total process for manufacturing the display substrate can be simplified, a manufacturing convenience can be enhanced and a cost price can also be reduced.

Having described the exemplary embodiments of the present invention and its advantages, it is noted that various changes, substitutions and alterations can be made herein without departing from the spirit and scope of the invention as defined by appended claims.

What is claimed is:

1. A display substrate of a display panel having a touch screen function detecting a coordinate of a touch point, the display substrate electrically connected to an array substrate at the touch point, the array substrate having a plurality of pixel portions, a first line and a second line formed thereon, the plurality of pixel portions defined by a plurality of gate lines and a plurality of data lines, the first and second lines detecting the touch point, the display substrate comprising:
a base substrate;
a supporting pattern directly formed on the base substrate with a first length, the supporting pattern maintaining a uniform separation distance from the array substrate; and
a first protrusion pattern and a second protrusion pattern directly formed on the base substrate with a second length, the first and second protrusion patterns electrically connected to the first and second lines respectively in the touch point.

2. The display substrate of claim 1, wherein the first length is longer than the second length.

3. The display substrate of claim 2, wherein the first and second protrusion patterns have a conductive layer formed thereon.

4. The display substrate of claim 3, wherein the first and second protrusion patterns are separated from each other by a predetermined distance.

5. The display substrate of claim 3, wherein the first and second protrusion patterns are formed adjacent to each other.

6. The display substrate of claim 3, further comprising a light-blocking layer formed on the base substrate, the light-blocking layer defining the base substrate into areas corresponding to the plurality of pixel portions, wherein the supporting pattern, and the first and second protrusion patterns are formed on the light-blocking layer.

7. The display substrate of claim 1, wherein the first and second protrusion patterns have a conductive layer formed thereon.

8. The display substrate of claim 7, further comprising a light-blocking layer formed on the base substrate, the light-blocking layer defining areas corresponding to the plurality of pixel portions, wherein the supporting pattern and the first and second protrusion patterns are formed on the light-blocking layer.

9. The display substrate of claim 1, wherein the supporting pattern and the first and second protrusion patterns are formed through a single exposure process.

10. A method for manufacturing a display substrate of a display panel having a touch screen function detecting a coordinate of a touch point, the display substrate electrically connected to an array substrate at the touch point, the array substrate having a plurality of pixel portions, a first line and a second line formed thereon, the plurality of pixel portions defined by a plurality of gate lines and a plurality of data lines, the first and second lines detecting the touch point, the method comprising:
coating an organic material layer on the base substrate;
disposing an exposure mask over an upper portion of the organic material layer such that the exposure mask is separated from the organic material layer, the exposure mask including a first mask pattern to form a supporting pattern, and a second mask pattern to form a first protrusion pattern and a second protrusion pattern;
exposing the organic material layer, while maintaining a separation distance between the exposure mask and the organic material layer uniformly; and
developing exposed organic material layer to form the supporting pattern and the first and second protrusion patterns.

11. The method of claim 10, further comprising forming a light-blocking layer on the base substrate, the light-blocking layer corresponding to areas defining the plurality of pixel portions.

12. The method of claim 11, wherein maintaining the separation distance between the exposure mask and the organic material layer controls a length of the supporting pattern and the protrusion patterns.

13. The method of claim 10, further comprising:
eliminating the organic material layer not corresponding to the supporting pattern and the first and second protrusion patterns;
forming a color filter layer;
forming a conductive layer on the base substrate having the color filter layer formed thereon;
patterning the conductive layer; and
eliminating the conductive layer in an area corresponding to the supporting element.

14. The method of claim 13, wherein forming the color filter layer includes using a spin coating process.

15. The method of claim 10, wherein the supporting pattern and the first and second protrusion patterns are formed by a proximity type exposure process.

16. A method for manufacturing a display substrate corresponding to an array substrate having a plurality of pixel portions and signal lines formed thereon, the plurality of pixel portions defined by a plurality of gate lines and a plurality of data lines, the signal lines detecting a touch point, the method comprising:
forming color filter patterns corresponding to the pixel portions on a base substrate;
forming an organic material layer on the base substrate having the color filter patterns formed thereon;
patterning the organic material layer, and forming a supporting pattern and a protrusion pattern having a different diameter, respectively;
forming a transparent electrode layer on the base substrate having the protrusion pattern formed thereon to form a protrusion electrode covering the protrusion pattern; and
forming the supporting pattern and the protrusion pattern having a different height from each other through a hot press process on the base substrate having the transparent electrode layer formed thereon.

17. The method of claim 16, wherein a diameter of the supporting pattern is larger than that of the protrusion pattern, and a height of the supporting pattern is substantially same as that of the protrusion pattern prior to the hot press process.

18. The method of claim 16, wherein the array substrate and the display substrate are combined using a sealant through the hot press process.

19. The method of claim 16, wherein the height of the protrusion pattern is lower than that of the supporting pattern after the hot press process.

20. The method of claim 16, wherein the supporting pattern maintains a gap between the array substrate and the display substrate, and wherein the protrusion electrode is electrically connected to the signal lines upon application of an external touch force.

21. A method for manufacturing a display substrate having a plurality of pixel portions, switching elements and signal lines formed thereon, the plurality of pixel portions defined by a plurality of gate lines and a plurality of data lines, a switching element formed on each pixel portion, the signal lines detecting a touch point, the method comprising:
forming an organic material layer on a base substrate having the switching elements formed thereon;
patterning the organic material layer to form a supporting pattern and a protrusion pattern having a different diameter respectively;
forming a transparent electrode layer on the base substrate having the supporting pattern and the protrusion pattern formed thereon;
patterning the transparent electrode layer to form a protrusion electrode covering the protrusion pattern and a pixel electrode electrically connected to the switching element; and
forming the supporting pattern and the protrusion pattern having a different height from each other through a hot press process on the base substrate having the pixel electrode formed thereon.

22. A display panel comprising:
an array substrate having a plurality of pixel portions, first signal lines and second signal lines formed thereon, the plurality of pixel portions defined by a plurality of gate lines and a plurality of data lines, the first and second signal lines detecting a touch point and formed in the same direction of the gate lines and the data lines respectively; and
an opposite substrate combined with the array substrate, and receiving a liquid crystal material,
wherein the opposite substrate comprises:
a light-blocking layer formed on a base substrate in areas corresponding to the gate lines and the data lines;
a supporting pattern directly formed on the light-blocking layer with a first length, the supporting pattern maintaining a uniform separation distance from the array substrate; and
a first protrusion pattern and a second protrusion pattern directly formed on the light-blocking layer with a second length.

23. The display panel of claim 22, wherein the first and second protrusion patterns are formed on the light-blocking layer in areas corresponding to the data lines.

24. The display panel of claim 23, wherein the first and second protrusion patterns are separated from each other by a predetermined distance.

25. The display panel of claim 23, wherein the first and second protrusion patterns are formed adjacent to each other.

26. The display panel of claim 22, wherein the first and second protrusion patterns have a conductive layer formed thereon.

27. The display panel of claim 26, wherein the array substrate further comprises a first detecting electrode and a second detecting electrode, the first and second detecting electrodes formed on the first and second signal lines respectively, and electrically connecting the first and second protrusion patterns having the conductive layer formed thereon to the first and second signal lines, respectively, at a touch point.

28. The display panel of claim 22, wherein the supporting pattern and the first and second protrusion patterns are formed by a proximity type exposure process.

29. The display panel of claim 28, wherein the first length is longer than the second length.

30. A display substrate of a display panel having a touch screen function detecting a coordinate of a touch point, the display substrate electrically connected to an opposite substrate at the touch point, the display substrate comprising:
a plurality of pixel portions defined by a plurality of gate lines extending in a first direction and a plurality of data lines extending in a second direction;
switching elements formed in the plurality of pixel portions;
first signal lines extending in the first direction;
second signal lines extending in the second direction;
a supporting pattern formed on the switching elements, the supporting pattern having a first length;
first and second protrusion patterns formed on the first and second signal lines, respectively, the first and second protrusion patterns having a second length less than the first length; and,
first and second sensing electrodes formed on the first and second protrusion patterns, respectively, the first and second sensing electrodes electrically connected to the first and second signal lines, respectively.
